(19) United States
(12) Patent Application Publication
(10) Pub. No.: US 2022/0090919 A1
(43) Pub. Date: Mar. 24, 2022

(54) SYSTEM, METHOD, AND COMPUTER PROGRAM PRODUCT FOR IDENTIFYING A LINK OFFSET

(71) Applicant: HERE Global B.V., Eindhoven (NL)

(72) Inventors: Zhenhua ZHANG, Chicago, IL (US); Leon STENNETH, Chicago, IL (US)

(21) Appl. No.: 17/096,630

(22) Filed: Nov. 12, 2020

Related U.S. Application Data
(60) Provisional application No. 63/082,836, filed on Sep. 24, 2020.

(51) Int. Cl. G01C 21/32; G08G 1/01; G01C 21/36; G06F 16/29

(52) U.S. Cl. CPC G01C 21/32; G06F 16/29; G01C 21/3667; G08G 1/0125

(57) ABSTRACT

A system, a method, and a computer program product are disclosed for identifying a link offset. The system may comprise a memory configured to store computer-executable instructions; and one or more processors configured to execute the instructions to: receive a first plurality of road object observations associated with at least one road object for a first link, wherein the first link is associated with a second link; determine a second plurality of road object observations from the first plurality of road object observations; determine an offset distance based on the second plurality of road object observations; and identify a road segment portion of the first link and a road segment portion of the second link as the link offset, based on the determined offset distance.

### RELATED APPLICATION

This application claims priority from U.S. Provisional Application Ser. No. 63/082,836, entitled “SYSTEM, METHOD, AND COMPUTER PROGRAM PRODUCT FOR IDENTIFYING A LINK OFFSET,” filed on Sep. 24, 2020, the contents of which are hereby incorporated herein in their entirety by this reference.

### TECHNOLOGICAL FIELD

The present disclosure generally relates to routing and navigation systems, and more particularly relates to identifying a link offset for routing and navigation applications.

### BACKGROUND

Currently, various navigation applications are available for vehicle navigation. These navigation applications generally request navigation related data from a navigation service. The navigation related data may include data about navigation routes and road objects on these routes such as road signs, traffic objects, road obstacles and the like. The navigation related data or map data thereof in the navigation service may be updated by sensor data associated with the road objects to provide up-to-date navigation related data on a requested route. Indeed, the sensor data associated with the road objects should be accurate to accurately provide the navigation related data. However, the sensor data associated with the road objects may not be accurate in identifying the road objects in road geometries such as merging links, ramp links, parallel links, and the like.

### BRIEF SUMMARY OF SOME EXAMPLE EMBODIMENTS

Some embodiments are based on recognition that the sensor data associated with the road objects or road object observations associated with the road objects may not be accurate, because sensors equipped in a vehicle may wrongly recognize the road objects associated with an another link as the road objects associated with a current link. For instance, the sensors of the vehicle may determine a road object associated with a ramp link, a parallel link, a merging link and like as a road object associated with a main link, when the vehicle is travelling through the main link. Hereinafter, the term ‘sensor data’ and ‘road object observation(s)’ may be interchangeably used to mean the same.

Further, according to some embodiments, when two links are merging at a location (also referred as a merging location) and if a road object is located on the merging location, then the road object corresponds to both the links. For instance, when a first link and a second link is merging at the merging location and if the road object is located on the merging location, then the road object is applicable for both the first link and the second link. As used herein, the merging location may be a location where two or more links merge. As used herein, the first link may be a road segment between two nodes or two intersections. As used herein, the second link may be a road segment between two nodes or two intersections. According to some embodiments, the road object located on the merging location may be identified as a road object associated with the first link, but may not be identified as the road object associated with the second link, if there are no vehicles travelling through the second link.

To that end, various embodiments are provided to identify a link offset that includes a road segment portion of the first link and a road segment portion of the second link, based on the road object observations received from the vehicle(s) travelling on the first link. In various embodiments, the identified link offset may be the road segment portion of the first link and the road segment portion of the second link for which the road object located on the merging location is applicable. Further, according to some embodiments, the identification of the link offset may be affected by road object observations associated with a road object that correspond to the ramp link (for instance, a third link). To that end, various embodiments are provided to determine the road object observations associated with the road object that correspond to the ramp link; and process the road object observations associated with the road object that correspond to the ramp link (for instance, a third link) using a ramp link algorithm. Furthermore, according to some embodiments, the identification of the link offset may be affected by road object observations associated with a road object that correspond to the parallel link (for instance, a fourth link). To that end, various embodiments are provided to determine the road object observations associated with the road object that correspond to the parallel link; and process the road object observations using a parallel link algorithm.

Various embodiments are provided for receiving a first plurality of road object observations associated with at least one road object for the first link. In various embodiments, the at least one road object may correspond at least one of a road object associated with the merging link (i.e. the second link), a road object associated with the ramp link (i.e. the third link), a road object associated with the parallel link (i.e. the fourth link), or a combination thereof. In various embodiments, the road object may comprise a road sign, a road obstacle, a traffic object, and the like. In various embodiments, the road sign may comprise a speed limit sign, a route guidance sign, a parking sign, a destination sign, a warning sign, and the like. In various embodiments, the road obstacle may comprise a road divider, a road work object, and the like. In various embodiments, the traffic object may comprise a traffic cone, a guide rail, and the like. In various embodiments, the first link may be associated with the second link. In various embodiments, the second link may be a link that is parallel to the first link and merging with the first link at the merging location.

Various embodiments are provided for determining a second plurality of road object observations from the first plurality of road object observations. In various embodiments, the second plurality of road object observations may be road object observation(s) associated with the road object located on the merging location of the first link and the second link.

Various embodiments are provided for determining an offset distance based on the second plurality of road object observations. In various embodiments, the offset distance for a second road object observation of the second plurality of road object observations is a distance from a location associated with the second road object observation to the merging location.

Various embodiments are provided for identifying the road segment portion of the first link and the road segment portion of the second link as the link offset, based on the determined offset distance. Various embodiments are provided for providing one or more navigation functions for the vehicle(s), based on the identified link offset. In various embodiments, control signals may be generated and provided for the vehicle(s) travelling on the first link and on the second link before the vehicle(s) reaches the merging location such that traffic congestions, accidents, increased travel time and the like are avoided at the merging location. For instance, the control signals may be generated and provided for the vehicle(s) travelling on the first link to provide at least one lane of the first link to one or more vehicles travelling on the second link to smoothly merge into the first link. For instance, the control signals may be generated and provided for the vehicle(s) travelling on the first link to deaccelerate or reduce the speed values associated with the vehicles(s) travelling on the first link, if the vehicle(s) is travelling a greater speed value than the speed value observed on the road object. For instance, the control signals may be generated and provided for the one or more vehicles travelling on the second link to accelerate the speed values associated with the one or more vehicles travelling on the second link, if the one or more vehicles are travelling a lesser speed value than the speed value observed on the road object.

Some other non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

A system, a method and a computer programmable product are provided in accordance with an example embodiment described herein for identifying a link offset.

In one aspect, a system for identifying a link offset is disclosed. The system may comprise a memory configured to store computer-executable instructions; and one or more processors configured to execute the instructions to: receive a first plurality of road object observations associated with at least one road object for a first link, wherein the first link is associated with a second link; determine a second plurality of road object observations from the first plurality of road object observations; determine an offset distance based on the second plurality of road object observations; and identify a road segment portion of the first link and a road segment portion of the second link as the link offset, based on the determined offset distance.

According to some embodiments, the one or more processors may be further configured to: determine whether the second link is merging into the first link within a first threshold distance from a location associated with each of the first plurality of road object observations; determine whether a heading difference data between a heading data associated with the first link and a heading data associated with the second link is less than a threshold heading difference data; determine a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data; and determine the second plurality of road object observations from the first plurality of road object observations such that the second plurality of road object observations are within the first threshold distance from the merging location.

According to some embodiments, the one or more processors may be further configured to: determine whether the second link is merging into the first link within a first threshold distance from a location associated with each of the first plurality of road object observations; determine whether a heading difference data between a heading data associated with the first link and a heading data associated with the second link is less than a threshold heading difference data; determine a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data; determine whether a location associated with the at least one road object is within the second threshold distance from the merging location; determine whether a third link exists within a third threshold distance from the location associated with the at least one road object, wherein the third link is a ramp link associated with the first link; determine a third plurality of road object observations from the first plurality of road object observations, in response to determining the location associated with the at least one road object is within the second threshold distance from the merging location and the third link exists within the third threshold distance from the location associated with at least one of the at least one road object; and remove the third plurality of road object observations from the first plurality of road object observations to determine the second plurality of road object observations.

According to some embodiments, the one or more processors may be further configured to: determine whether a fourth link and the second link exist on a same side for each of the first plurality of road object observations, wherein the fourth link is a link parallel to the first link; determine a fourth plurality of road object observations from the first plurality of road object observations, in response to determining the fourth link and a second link exist on the same side; and remove the fourth plurality of road object observations from the first plurality of road object observations to determine the second plurality of road object observations.

According to some embodiments, wherein the offset distance is a distance from a location associated with a second road object observation of the second plurality of road object observations to the merging location.

According to some embodiments, the one or more processors may be further configured to: determine a mean offset distance from the offset distance for each of the second plurality of road object observations; determine a first offset location on the first link from the merging location, based on the mean offset distance; determine a second offset location on the second link from the merging location, based on the mean offset distance; and identify the road segment portion of the first link from the first offset location to the merging location and the road segment portion of the second link from the second offset location to the merging location as the link offset.

According to some embodiments, the one or more processors may be further configured to update a map database, based on the identified link offset.

According to some embodiments, the one or more processors may be further configured to provide one or more navigation functions for a vehicle, based on the identified link offset.

In another aspect, a computer program product comprising a non-transitory computer readable medium having stored thereon computer executable instruction which when executed by one or more processors, cause the one or more processors to carry out operations for identifying a road object, the operations comprising: receiving a first plurality of road object observations associated with the road object; determining, based on the received first plurality of road object observations, at least a first link and a second link, wherein the first link is a link associated with the road object and the second link is proximate to the first link; determining a second plurality of road object observations from the first plurality of road object observations based on a filtering criteria; determining an offset distance for each of the first link and the second link based on the second plurality of road object observations; and identifying the road object based on the offset distance, wherein identifying the at least one road object comprises associating the at least one road object with at least one of the first link and the second link based on the offset distance.

According to some embodiments, the operations may further comprise: extracting a road object value associated with the road object based on the second plurality of road object observations; and associating the road object and the extracted road object value with each of the first link and the second link based on the offset distance to identify the road object for each of the first link and the second link; wherein the offset distance is used to determine a portion of segment, for each of the first link and the second link, on which the extracted road object value is applied.

According to some embodiments, the filtering criteria may comprise one or more of a merging link criteria, a merging heading difference criteria, a ramp link criteria, and a parallel link criteria.

According to some embodiments, the operations may further comprise: determining the second plurality of road object observations based on the merging link criteria and the merging heading difference criteria, wherein the merging link criteria comprises determining that the second link is merging into the first link at a merging location, and wherein a distance between the merging location and a location associated with each road object observation in the second plurality of road object observations is within a first threshold distance; and wherein the merging heading difference criteria comprises determining that a heading difference data between a heading data associated with the first link and a heading data associated with the second link is less than a threshold heading difference data.

According to some embodiments, the operations may further comprise: determining the second plurality of road object observations based on the ramp link criteria, wherein the ramp link criteria comprises: determining whether a location associated with the road object is within a second threshold distance from the merging location; determining whether a third link exists within a third threshold distance from the location associated with the at least one road object, wherein the third link is a ramp link; determining a third plurality of road object observations, in response to determining the location associated with the road object is within the second threshold distance from the merging location and the third link is located within a third threshold distance from the location associated with the at least one road object; and determining the second plurality of road object observations by removing the third plurality of road object observations from the first plurality of road object observations.

According to some embodiments, the third plurality of road object observations may be transmitted to a ramp processing algorithm component for further processing.

According to some embodiments, the operations may further comprise: determining the second plurality of road object observations based on the parallel link criteria, wherein the parallel link criteria comprises: determining a fourth plurality of road object observations, wherein each road object observation in the fourth plurality of road object observations is associated with the second link and at least one fourth link, wherein the second link and the fourth link are on a same side of the first link; and determining the second plurality of road object observations by removing the fourth plurality of road object observations from the first plurality of road object observations.

In yet another aspect, a method for identifying a link offset is disclosed. The method may comprise receiving a first plurality of road object observations associated with at least one road object for a first link, wherein the first link is associated with a second link; determining a second plurality of road object observations from the first plurality of road object observations; determining an offset distance based on the second plurality of road object observations; and determining a first offset location on the first link and a second offset location on the second link for identifying the link offset, based on the determined offset distance.

According to some embodiments, the method may further comprise: determining whether the second link is merging into the first link within a first threshold distance from a location associated with each of the first plurality of road object observations; determining whether a heading difference data between a heading data associated with the first link and a heading data associated with the second link is less than a threshold heading difference data; determining a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data; and determining the second plurality of road object observations from the first plurality of road object observations such that the second plurality of road object observations are within the first threshold distance from the merging location.

According to some embodiments, the method may further comprise: determining whether the second link is merging into the first link within a first threshold distance from a location associated with each of the first plurality of road object observations; determining whether a heading difference data between a heading data associated with the first link and a heading data associated with the second link is less than a threshold heading difference data; determining a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data; determining whether a location associated with the at least one road object is within the second threshold distance from the merging location; determining whether a third link exists within a third threshold distance from the location associated with the at least one road object, wherein the third link is a ramp link associated with the first link; determining a third plurality of road object observations from the first plurality of road object observations, in response to determining the location associated with the at least one road object is within the second threshold distance from the merging location and the third link exists within the third threshold distance from the location associated with at least one of the at least one road object; and removing the third plurality of road object observations from the first plurality of road object observations for determining the second plurality of road object observations.

According to some embodiments, the method may further comprise: determining whether a fourth link and the second link exist on a same side for each of the first plurality of road object observations, wherein the fourth link is a link parallel to the first link; determining a fourth plurality of road object observations from the first plurality of road object observations, in response to determining the fourth link and a second link exist on the same side; and removing the fourth plurality of road object observations from the first plurality of road object observations for determining the second plurality of road object observations.

According to some embodiments, the offset distance is a distance from a location associated with a second road object observation of the second plurality of road object observations to the merging location.

According to some embodiments, the method may further comprise: determining a mean offset distance from the offset distance for each of the second plurality of road object observations; determining the first offset location on the first link from the merging location, based on the mean offset distance; determining the second offset location on the second link from the merging location, based on the mean offset distance; and identifying a road segment portion of the first link from the first offset location to the merging location and a road segment portion of the second link from the second offset location to the merging location as the link offset.

According to some embodiments, the method may further comprise updating a map database, based on the identified link offset.

According to some embodiments, the method may further comprise providing one or more navigation functions for a vehicle, based on the identified link offset.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing an example architecture of a system for identifying a link offset, in accordance with one or more example embodiments;

FIG. 2 illustrates a block diagram of the system for identifying the link offset, in accordance with one or more example embodiments;

FIG. 3A illustrates a schematic diagram of an exemplary working environment of the system 101 for identifying the link offset in merging links road geometry, in accordance with one or more example embodiments;

FIG. 3B illustrates a schematic diagram for receiving a first plurality of road object observations, in accordance with one or more example embodiments;

FIG. 3C illustrates a schematic diagram for determining a second plurality of road object observations from the first plurality of road object observations, in accordance with one or more example embodiments;

FIG. 3D illustrates a schematic diagram for identifying a road segment portion of a first link and a road segment portion of a second link as the link offset, in accordance with one or more example embodiments;

FIG. 4A illustrates a schematic diagram of an exemplary working environment of the system for identifying the link offset in merging links and ramp links road geometry, in accordance with one or more example embodiments;

FIG. 4B illustrates a schematic diagram for receiving a first plurality of road object observations, in accordance with one or more example embodiments;

FIG. 4C illustrates a schematic diagram for determining a second plurality of road object observations from the first plurality of road object observations, in accordance with one or more example embodiments;

FIG. 5A illustrates a schematic diagram of an exemplary working environment of the system in merging links and parallel links road geometry, in accordance with one or more example embodiments;

FIG. 5B illustrates a schematic diagram for receiving a first plurality of road object observations, in accordance with one or more example embodiments;

FIG. 6A illustrates a schematic diagram of an exemplary working environment of the system for a real-time link offset identification in a complex road geometry, in accordance with one or more example embodiments;

FIG. 6B illustrates a schematic diagram for receiving a first plurality of road object observations, in accordance with one or more example embodiments;

FIG. 6C illustrates a schematic diagram for determining a second road object observation from the first plurality of road object observation, in accordance with one or more example embodiments;

FIG. 7A illustrates a flowchart depicting a method for identifying a link offset, in accordance with one or more example embodiments;

FIG. 7B illustrates a flowchart depicting a method for determining the second plurality of road object observations from the first plurality of road object observations, in accordance with one or more example embodiments; and

FIG. 7C illustrates a flowchart depicting a method for identifying the road segment portion of the first link and the road segment portion of the second link as the link offset, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for identifying a link offset. Various embodiments are provided for receiving a first plurality of road object observations associated with at least one road object for the first link. In various embodiments, the at least one road object may correspond at least one of a road object associated with the merging link (i.e. the second link), a road object associated with the ramp link (i.e. the third link), a road object associated with the parallel link (i.e. the fourth link), or a combination thereof. In various embodiments, the road object may comprise a road sign, a road obstacle, a traffic object, and the like. In various embodiments, the road sign may comprise a speed limit sign, a route guidance sign, a parking sign, a destination sign, a warning sign, and the like. In various embodiments, the road obstacle may comprise a road divider, a road work object, and the like. In various embodiments, the traffic object may comprise a traffic cone, a guide rail, and the like. In various embodiments, the first link may be associated with the second link. In various embodiments, the second link may be a link that is parallel to the first link and merging with the first link at the merging location.

Various embodiments are provided for determining a second plurality of road object observations from the first plurality of road object observations. In various embodiments, the second plurality of road object observations may be road object observation(s) associated with the road object located on the merging location of the first link and the second link.

Various embodiments are provided for determining an offset distance based on the second plurality of road object observations. In various embodiments, the offset distance for a second road object observation of the second plurality of road object observations is a distance from a location associated with the second road object observation to the merging location.

Various embodiments are provided for identifying the road segment portion of the first link and the road segment portion of the second link as the link offset, based on the determined offset distance. Various embodiments are provided for providing one or more navigation functions for the vehicle(s), based on the identified link offset. In various embodiments, control signals may be generated and provided for the vehicle(s) travelling on the first link and on the second link before the vehicle(s) reaches the merging location such that traffic congestions, accidents, increased travel time and the like are avoided at the merging location. For instance, the control signals may be generated and provided for the vehicle(s) travelling on the first link to provide at least one lane of the first link to one or more vehicles travelling on the second link to smoothly merge into the first link. For instance, the control signals may be generated and provided for the vehicle(s) travelling on the first link to deaccelerate or reduce the speed values associated with the vehicles(s) travelling on the first link, if the vehicle(s) is travelling a greater speed value than the speed value observed on the road object. For instance, the control signals may be generated and provided for the one or more vehicles travelling on the second link to accelerate the speed values associated with the one or more vehicles travelling on the second link, if the one or more vehicles are travelling a lesser speed value than the speed value observed on the road object.

Some other non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

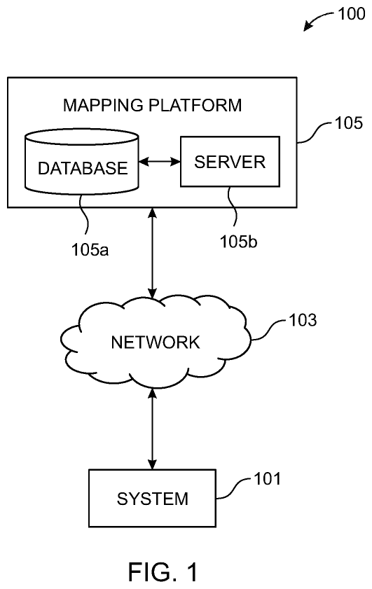

FIG. 1 illustrates a block diagram 100 showing an example architecture of a system 101 for identifying a link offset, in accordance with one or more example embodiments. As illustrated in FIG. 1, the block diagram 100 may comprise the system 101, a network 103, and a mapping platform 105. The mapping platform 105 may further comprise a map database 105a (also referred to as a database 105a) and a server 105b. In various embodiments, the system 101 may be an (Original Equipment Manufacturer) OEM cloud. To that end, the system 101 may be a server (for instance, a backend server, a remotely located server, or the like), group of servers, distributed computing system, and/or other computing system. In some embodiments, the system 101 may be onboard a vehicle, such as the system 101 may be a navigation system installed in the vehicle. In various embodiments, the vehicle may be an autonomous vehicle, a semiautonomous vehicle, or a manual vehicle. In an embodiment, the system 101 may be the server 105b of the mapping platform 105 and therefore may be co-located with or within the mapping platform 105. The system 101 may be communicatively coupled with the mapping platform 105 over the network 103.

The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The system 101 may communicate with the mapping platform 105, via the network 103, where the mapping platform 105 may comprise the map database 105a for storing map data, and the processing server 105b for carrying out the processing functions associated with the mapping platform 105. The map database 105a may store node data, road segment data or link data, point of interest (POI) data, road obstacles related data, traffic objects related data, posted signs related data, such as road sign data or the like. The map database 105a may also include cartographic data and/or routing data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road/link data and the node data may represent a road network, such as used by vehicles, for example, cars, trucks, buses, motorcycles, and/or other entities.

Optionally, the map database 105a may contain path segment and node data records or other data that may represent pedestrian paths or areas in addition to or instead of the vehicle road record data, for example. The road/link segments and nodes may be associated with attributes, such as geographic coordinates, street names, address ranges, lane level speed profile (historically derived speed limits for a lane), lane level maneuver pattern (lane change patterns at intersections), and other navigation related attributes, as well as POIs, such as fueling stations, hotels, restaurants, museums, stadiums, offices, auto repair shops, buildings, stores, parks, etc. The map database 105a may include data about the POIs and their respective locations in the POI records. The map database 105a may additionally include data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 105a may include event data (e.g., traffic incidents, construction activities, scheduled events, unscheduled events, etc.) associated with the POI data records or other records of the map database 105a. The map database 105a may additionally include data related to road signs, road obstacles, traffic objects and the like. Each of the road objects and/or road segments, nodes, POIs, or other geographic map features or records of a geographic database may be associated with a plurality of attributes, including but not limited to, a road object value, a road object location, a road object heading, a road object type and the like. The road object value may be related to the information associated with the map parameter identified by the road object. For example, in case the road object is a speed sign, the road object value is the speed limit value depicted on the speed sign. The system 101 may be configured to provide an update for map database 105 regarding any or all of the road object attributes, based on identifying the link offset. For example, the system 101 identifies the link offset and an associated link offset location, and subsequently, map database 105a is updated to include the road object attribute value, such as speed limit value for a speed sign, for the link offset location and the portion of link identified as link offset, in map database 105a. The map database may be communicatively coupled to the processing server 105b.

The processing server 105b may comprise one or more processors configured to process requests received from the system 101. The processor may fetch map data from the map database 105a and transmit the same to the system 101 in a format suitable for use by the system 101. In some example embodiments, as disclosed in conjunction with the various embodiments disclosed herein, the system 101 may be used to identify the link offset.

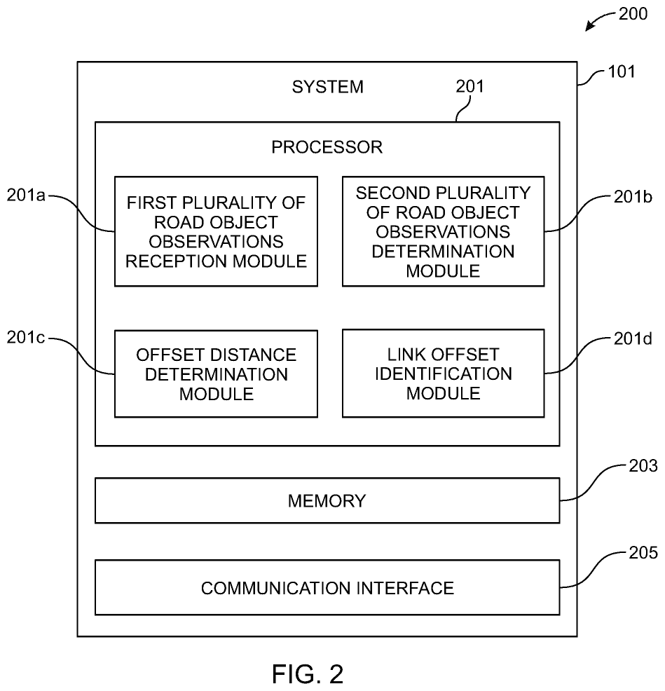

FIG. 2 illustrates a block diagram 200 of the system 101 for identifying the link offset, in accordance with one or more example embodiments. The system 101 may include a processing means such as at least one processor 201, storage means such as a memory 203, and a communication means such as at least one communication interface 205. Further, the system 101 may comprise a first plurality of road object observations reception module 201a, a second plurality of road object observations determination module 201b, an offset distance determination module 201c, and a link offset identification module 201d. In various embodiments, the first plurality of road object observations reception module 201a may be configured to receive a first plurality of road object observations associated with at least one road object for a first link. In various embodiments, the second plurality of road object observations determination module 201b may be configured to determine a second plurality of road object observations from the first plurality of road object observations received by the first plurality of road object observations reception module 201a. In various embodiments, the offset distance determination module 201c may be configured to determine an offset distance for each of the second plurality of road object observations determined by the second plurality of road object observations determination module 201b. In various embodiments, the link offset identification module 201d may be configured to identify a road segment portion of the first link and a road segment portion of the second link as the link offset, based on the offset distances determined by the offset distance determination module 201c.

According to some embodiments, each of the modules 201a, 201b, 201c, and 201d may be embodied in the processor 201. The processor 201 may retrieve computer program code instructions that may be stored in the memory 203 for execution of computer program code instructions, which may be configured for identifying the link offset.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

Additionally, or alternatively, the processor 201 may include one or more processors capable of processing large volumes of workloads and operations to provide support for big data analysis. In an example embodiment, the processor 201 may be in communication with a memory 203 via a bus for passing information to mapping platform 105. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to users of the system 101, where the users may be a traveler, a rider, a pedestrian, a driver of the vehicle and the like. In some embodiments, the users may be or correspond to an autonomous or semi-autonomous vehicle. The IoT related capabilities may in turn be used to provide smart navigation solutions by providing real time updates to the users to take pro-active decision on speed determination, lane-level speed determination, turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101. For example, the communication interface may comprise I/O interface which may be in the form of a GUI, a touch interface, a voice enabled interface, a keypad, and the like. For example, the communication interface may be a touch enabled interface of a navigation device installed in a vehicle, which may also display various navigation related data to the user of the vehicle. Such navigation related data may include information about upcoming conditions on a route, route display, alerts about vehicle speed, user assistance while driving, and the like.

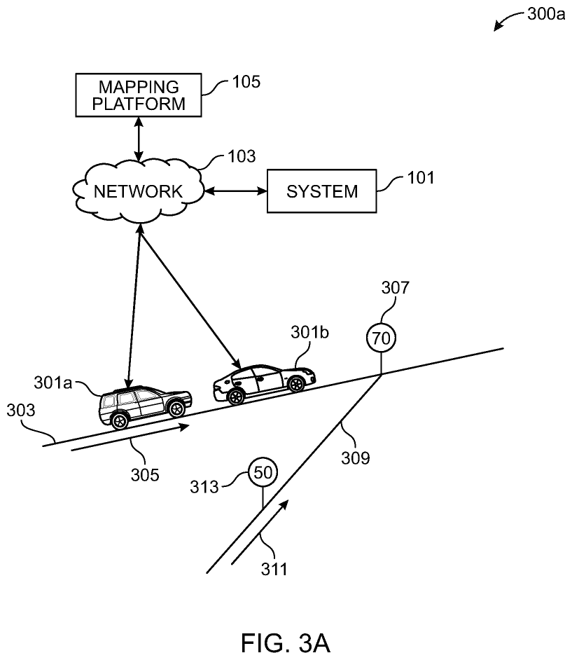

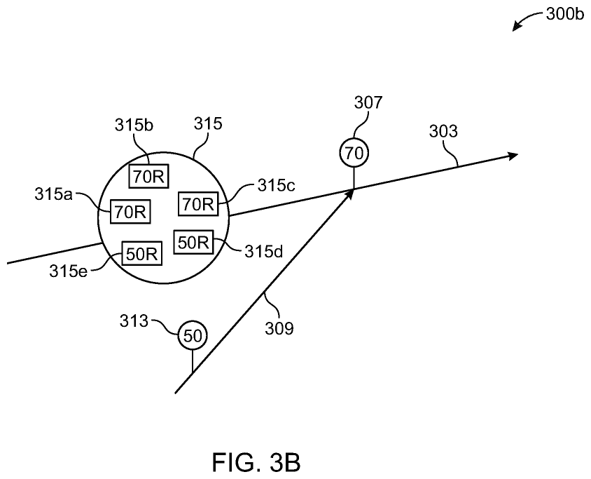

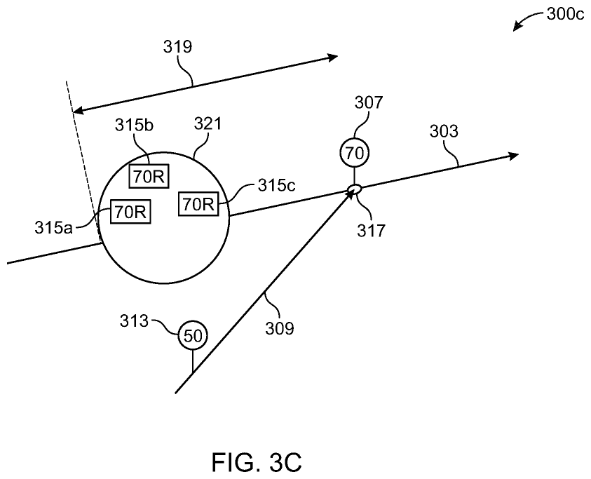

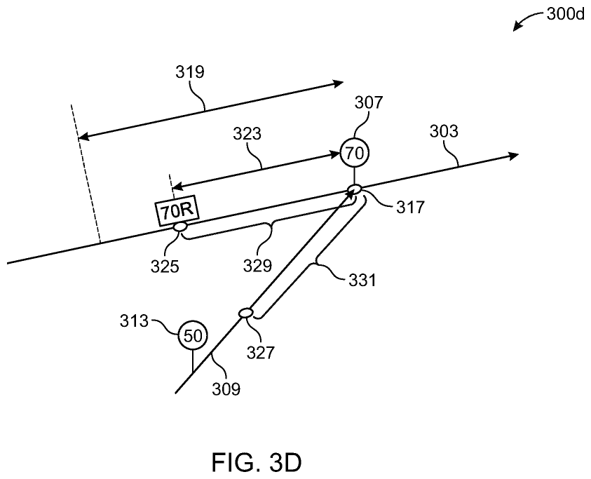

FIG. 3A illustrates a schematic diagram 300a of an exemplary working environment of the system 101 for identifying a link offset in merging links road geometry, in accordance with one or more example embodiments. As illustrated in FIG. 3A, the schematic diagram 300a may comprise the system 101, the network 103, the mapping platform 105, a vehicle 301a, a vehicle 301b, a first link 303, a travel direction 305 associated with the first link 303, a road object 307, a second link 309 associated with the first link 303, and a travel direction 311 associated with the second link 309 and a road object 313. In various embodiments, the vehicles 301a and 301b may be autonomous vehicles, semiautonomous vehicles, or manual vehicles. In various embodiments, each of the vehicles 301a and 301b may be equipped with sensors such as a camera sensor, a RADAR sensor, a LIDAR sensor and like for collecting road object observations for the road objects such as the road object 307, when travelling through the first link 303 in the travel direction 305. As used herein, the first link 303 may refer to a road segment between two nodes or two intersections. As used herein, a travel direction 305 may refer to a direction of travel of vehicles such as the vehicles 301a and 301b on the first link 303. In various embodiments, the first link 303 may be a current map-matched link, when the vehicles 301a and 301b are travelling through the first link 303. For instance, the system 101 may constantly obtain location data (GPS (Global positioning system) coordinate data) of the vehicle 301a and 301b and map-match the obtained location data with the map data of the map-database 105a to determine the first link 303 as the current map-matched link, when the vehicle 301 is traveling on the first link 303. In various embodiments, the first link 303 may correspond to a freeway, a highway, an expressway, and the like. In various embodiments, the first link 303 may be associated with the second link 309 if the travel direction 305 associated with the first link 303 and the travel direction 311 associated with the second link 309 are similar. In various embodiments, the second link 309 may be a road segment between two nodes or two intersections. In various embodiments, the second link 309 may be the link merging or converging into the first link 303. In other words, the second link 309 may be the link whose travel direction 311 is similar to the travel direction 305 associated with the first link 303 and the travel direction 311 is merging into the first link 303. To that end, the second link 309 may be referred as a merging link to the first link 303. As used herein, the travel direction 311 may refer to a direction of travel of vehicles such as the vehicles 301a and 301b on the second link 309.

In various embodiments, the first link 303 and the second link 309 may comprise one or more road objects such as the road object 307 and the road object 313. As exemplary illustrated in FIG. 3A, the road object 307 may be located on a merging location of the first link 303 and the second link 309. To that end, the road object 307 may be applicable to both the first link 303 and the second link 309. In other words, the road object 307 may be a road object for the first link 303 and the second link 309. As used herein, the merging location may be a location where two or more links merge or converge. In various embodiments, the road object 307 may comprise at least one of a road sign, a road obstacle, a traffic object, and the like. In various embodiments, the road sign may comprise a speed limit sign, a route guidance sign, a parking sign, a destination sign, a warning sign, and the like. In various embodiments, the road obstacle may comprise a road divider, a road work object, and the like. In various embodiments, the traffic object may comprise a traffic cone, a guide rail, and the like. In various embodiments, the road object 313 may be associated with the second link 309 as the road object 313 is located on the second link 309. Further, the road object 311 may comprise at least one of the road sign, the road obstacle, the traffic object, and the like.

In various embodiments, the vehicles 301a and 301b (i.e. the sensors of the vehicles 301a and 301b) may be configured to collect road object observations associated with the road objects such as the road object 307 for the first link 303, when travelling through the first link 303. Indeed, the sensors of the vehicle 301a and 301b may be configured to collect the road object observations associated the road objects located within a threshold distance from locations of the vehicles 301a and 301b. As a result, the sensors may wrongly collect the road object observations associated with the road object 313 located on the second link 309 for the first link 303, when the road object 313 located on the second link 309 is within the threshold distance. Therefore, the road object observations collected by the sensors of the vehicle 301a and 301b may not be accurate. Further, the road object 307 is applicable for both the first link 303 and the second link 309 as the road object 307 is located on or within a threshold distance from the merging location (i.e. near the merging location). According to some embodiments, the road object 307 may not be identified as the road object 307 associated with the second link 309, when there are no vehicles travelling on the second link 309. To that end, the system 101 may be configured to remove the road object observations associated with the road object 313 from the road object observations received from the sensors of the vehicles 301a and 301b and identify a road segment portion of the first link 303 and a road segment portion of the second link 309 as a link offset for the road object 307 located on the merging location. Accordingly, the system 101 may be configured to receive, from the sensors of the vehicles 301a and the vehicle 301b, a first plurality of road object observations associated with the road object 307 and the road object 313 for the first link 303. Here for the purpose of explanation, the system 101 receiving the first plurality of road object observations associated with the road object 307 and the road object 313 are considered, however, in most scenarios the road object 313 may not be located on the second link 309. To that end, the system 101 may be configured to receive the first plurality of road object observations associated with the road object 307. Further, the first plurality of road object observations received from the sensor of the vehicles 301a and 301b may be as explained in the detailed description of FIG. 3B.

FIG. 3B illustrates a schematic diagram 300b for receiving an exemplary first plurality of road object observations 315, in accordance with one or more example embodiments. In various embodiments, the system 101 may be configured to receive the first plurality of road object observations 315 associated with the road object 307 and the road object 313 for the first link 303. For instance, the first plurality of road object observations reception module 201a may be configured to receive the first plurality of road object observations 315 associated with the road object 307 and the road object 305 for the first link 303. In some embodiments, the system 101 may be configured to receive the first plurality of road object observations 315 associated with the road object 307 and the road object 313. Further, the system 101 may be configured to determine, using the map database 105a, at least the first link 303 and the second link 309, based on the first plurality of road object observations 315. The second link may be the link proximate to the first link as illustrated in FIG. 3A. As illustrated in FIG. 3B, the first plurality of road object observations 315 may comprise road object observations 315a, 315b, and 315c associated with the road object 307 and road object observations 315d and 315e associated with the road object 313. In various embodiments, the road object observation 315a may comprise a location of the vehicle 301a or the vehicle 301b at where the road object observation 315a was made and road object information of the road object 307. In some example embodiments, the road object information of the road object 307 may comprise a road object value of the road object 307 and information regarding whether the road object is located on right side of the first link 303 or left side of the first link 303. For instance, the road object information of the road object 307 may comprise a speed limit value of the speed limit sign and the information regarding whether the speed limit sign is located on right side of the first link 303 or left side of the first link 303. As used herein, the right side of the first link 303 and the left side of the first link 303 may be determined based on the travel direction 305 associated with the first link 303. Additionally, the road object observation 315a may comprise timestamp data indicating a time instance (also includes date, month, and year) at which the road object observation 315a was made.

Similarly, the road object observations 315b and 315c may comprise locations where the road object observations 315b and 315c were made for the road object 307 and road object information of the road object 307. Further, the road object observations 315d and 315e may comprise locations where the road object observations 315d and 315e were made for the road object 313 and road object information of the road object 313. Additionally, each of the road object observations 315b, 315c, 315d, and 315e may comprise the timestamp data as explained with respect to the road object observation 315a. Further, the system 101 may determine a second plurality of road object observations from the first plurality of road object observations 315 as explained in the detailed description of FIG. 3C.

FIG. 3C illustrates a schematic diagram 300c for determining a second plurality of road object observations 321 from the first plurality of road object observations 315, in accordance with one or more example embodiments. In various embodiments, the system 101 may be configured to determine the second plurality of road object observations 321 from the first plurality of road object observations 315. For instance, the second plurality of road object observations determination module 201b may be configured to determine the second plurality of road object observations 321 from the first plurality of road object observations 315.

Once the first plurality of road object observations 315 are received by the system 101, in various embodiments, the system 101 may be configured to determine whether the second link 309 is merging into the first link 303 within a first threshold distance 319 from the location associated with each of the first plurality of road object observations 315. For instance, the system 101 may determine whether the second link 309 is merging into the first link 303 within a first threshold distance 319 from the locations of the road object observations 315a, 315b, 315c, 315d, and 315e. In other words, the system 101 may be configured to execute a merging link criteria after receiving the first plurality of road object observations 315. In some embodiments, the merging link criteria may be a condition to determine whether the second link 309 is merging into the first link 303 within the first threshold distance 319 from the location associated with each of the first plurality of road object observations 315. In various embodiments, the first threshold distance 319 may be a predetermined distance. In some example embodiments, the first threshold distance 319 may be hundred meter. In some example embodiments, the first threshold distance 319 may be determined based on experimentation and the like. In some embodiments, the system 101 may be configured to terminate the process of identifying the link offset, in response to determining the second link 309 is not merging into the first link 303 within the first threshold 319 from each of the first plurality of road object observations 315 (i.e. the location associated with each of the first plurality of road object observations 315).

In various embodiments, the system 101 may be configured to determine a heading data associated with the first link 303 and a heading data associated with the second link 309, in response to determining the second link 309 is merging into the first link 303 within the first threshold 319 from the location associated with at least one of the first plurality of road object observations 315. As used herein, the heading data may be an angle measured in degree or its equivalent from a north direction, a line-of-sight direction, or the like in clockwise direction. In some example embodiments, the system 101 may determine the heading data associated with the first link 303 and the heading data associated with the second link 309 using the map database 105a.

In various embodiments, the system 101 may be configured to determine a heading difference data between the heading data associated with the first link 303 and the heading data associated with the second link 309. For instance, the system 101 may subtract the heading data associated with the first link 303 from the heading data associated with the second link 309 or the heading data associated with the second link 309 from the heading data associated with the first link 303 to determine the heading difference data.

In various embodiments, the system 101 may be configured to determine whether the heading difference data between the heading data associated with the first link 303 and the heading data associated with the second link 309 is less than a threshold heading difference data. In other words, the system 101 may execute a merging heading difference criteria. In some embodiments, the merging heading difference criteria may be a condition to determine whether the heading difference data between the heading data associated with the first link 303 and the heading data associated with the second link 309 is less than the threshold heading difference data. In various embodiments, the threshold heading difference data may be a predetermined heading difference data. For instance, the threshold heading difference data may be forty degree or its equivalent. In some example embodiments, the threshold heading difference data may be determined based on experimentation and the like. In some embodiments, the system 101 may be configured to terminate the process of identifying the link offset, in response to determining the heading difference data between the heading data associated with the first link 303 and the heading data associated with the second link 309 is not less than the threshold heading difference data.

In various embodiments, the system 101 may be configured to determine a merging location 317 for the first link 303 and the second link 309, in response to determining the second link 309 is merging into the first link 303 within the first threshold distance 319 from the location associated with at least one of the first plurality of road object observations 315 and the heading difference data between the heading data associated with the first link 303 and the heading data associated with the second link 309 is less than the threshold heading difference data. In some example embodiments, the system 101 may determine, using the map database 105a, a location where the first link 303 and the second link 309 are merging as the merging location 317.

In various embodiments, the system 101 may be configured to determine the second plurality of road object observations 321 from the first plurality of road object observations 315 such that the second plurality of road object observations 321 are within the first threshold distance 319 from the merging location 317. In other words, the system 101 may extract the second plurality of road object observations 321 from the first plurality of road object observations 315 such that the location associated with each of the second plurality of road object observations 321 are within the first threshold distance 319 from the from the merging location. To that end, the system 101 may filter the second plurality of road object observations 321 from the first plurality of road object observations 315, based on the first distance threshold 319 criteria. The determined second plurality of road object observations 321 may comprise the first plurality of road object observations 315 associated with the road object 307 and/or the road object 315, which are within the first threshold distance 319 from the merging location 317.

To that end, the system 101 may be further configured to remove the road object observations 315d and 315e associated with the road object 313 from the determined second plurality of road object observations 321, if the determined second plurality of road object observations 321 comprises the road object observations 315d and 315e associated with the road object 313. According to some embodiments, the road objects (for instance, speed limit signs) on the second link 309 (i.e. the link merging into the first link 303) may have less road object values (for instance, speed limit values), when compared to the road objects (for instance, speed limit signs) on the first link 303.

To that end, the system 101 may further be configured to determine the second plurality of road object observations 321 from the first plurality of road object observations, based on a road object value criteria for removing the road object observations 315d and 315e associated with the road object 313. In some embodiments, the system 101 may determine the road object observations 315a, 315b, and 315c of the first plurality of road object observations 315 as the second plurality of road object observations 321, because the locations associated with the road object observations 315a, 315b, and 315c are within the first threshold distance 319 and the road object observations 315a, 315b, and 315c have lager road object values when compared to the road object values of the road object observations 315d and 315e of the first plurality of road object observations 315. Therefore, the system 101 may remove in accurate road object observations (i.e. the road object observations 315d and 315e associated with the road object 313) for the first link 303. Further, the system 101 may use accurate road object observations (i.e. the road object observations 315a, 315b, 315c associated with the road object 307) for identifying the link offset for the road object 307.

In various embodiments, the system 101 may be configured to determine an offset distance for each of the second plurality of road object observations 321. For instance, the offset distance determination module 201c may be configured to determine an offset distance for each of the second plurality of road object observations 321. In some example embodiments, the system 101 may determine a distance from the location associated with the road object observations 315a of the second plurality of road object observations 321 to the merging location 317 as the offset distance for the road object observation 315a of the second plurality of road object observations 321. In some other embodiments, the system 101 may determine a distance from the location associated with the road object observations 315a of the second plurality of road object observations 321 to a location associated with the road object 307 as the offset distance for the road object observation 315a of the second plurality of road object observations 321, when the road object 307 is located on the merging location 317. To that end, the offset distance for the road object observation 315a may be the distance from the location associated with the road object observation 315a to the merging location 317.

Similarly, the system 101 may determine the offset distance for the road object observations 315b and 315c of the second plurality of road object observations 321. To that end, the system 101 may determine the offset distance for each of the second plurality of road object observations 321. Further, the system 101 may identify a road segment portion of the first link 303 and a road segment portion of the second link 309 as the link offset, based on the offset distance for each of the second plurality of road object observations 321 as explained in the detailed description of FIG. 3D.

FIG. 3D illustrates a schematic diagram 300d for identifying a road segment portion 329 of the first link 303 and a road segment portion 331 of the second link 309 as the link offset, in accordance with one or more example embodiments. In various embodiments, the system 101 may be configured to identify the road segment portion 329 of the first link 303 and the road segment portion 331 of the second link 309 as the link offset, based on the offset distance for each of the second plurality of road object observations 321. For instance, the link offset identification module 201d may be configured to identify the road segment portion 329 of the first link 303 and the road segment portion 331 of the second link 309 as the link offset, based on the offset distance for each of the second plurality of road object observations 321.

Once the offset distance is determined for each of the second plurality of road object observations 321, in various embodiments, the system 101 may be configured to determine a mean offset distance 323 from the offset distance for the each of the second plurality of road object observations 321. For instance, the system 101 may average the offset distances of the road object observations 315a, 315b, and 315c of the second plurality of road object observations 321 to determine the mean offset distance 323.

In various embodiments, the system 101 may be configured to determine a first offset location 325 on the first link 303 from the merging location 317, based on the mean offset distance 323. For instance, the system 101 may determine a location on the first link 303 as the first offset location 325, if the location on the first link 303 is located at the distance equivalent to the mean offset distance 323 from the merging location 317. In some other example embodiments, the system 101 may be configured to determine the first offset location 325 on the first link 303 from the location associated with the road object 307, based on the mean offset distance 323, if the road object 307 is located on the merging location 317.

In various embodiments, the system 101 may be configured to determine a second offset location 327 on the second link 309 from the merging location 317, based on the mean offset distance 323. For instance, the system 101 may determine a location on the second link 309 as the second offset location 327, if the location on the second link 309 is located at the distance equivalent to the mean offset distance 323 from the merging location 317. In some other example embodiments, the system 101 may be configured to determine the second offset location 327 on the second link 309 from the location associated with the road object 307, based on the mean offset distance 323, if the road object 307 is located on the merging location 317.

In various embodiments, the system 101 may be configured to identify the road segment portion 329 of the first link 303 from the first offset location 325 to merging location 317 and the road segment portion 331 of the second link 309 from the second offset location 327 to merging location 317 as the link offset. In some embodiments, the road segment portion 329 may be a portion of the road segment of the first link 303 from the first offset location 325 to merging location 317. In some other embodiments, the road segment portion 329 may be a portion of the road segment of the first link 303 from the first offset location 325 to the location associated with the road object 307, if the road object 307 is located on the merging location 317. In some embodiments, the road segment portion 331 may be a portion of the road segment of the second link 309 from the second offset location 327 to the merging location 317. In some other embodiments, the road segment portion 331 may be a portion of the road segment of the second link 309 from the second offset location 327 to the location associated with the road object 307, if the road object 307 is located on the merging location 317.

In this way, the system 101 may identify the road segment portion 329 of the first link 303 and the road segment portion 331 of the second link 309 as the link offset for the road object 307. In various embodiments, the identified link offset may include the road segment portions 329 and 331 of the first link 303 and the second link 309 respectively for which the road object 307 located at the merging location 317 is applicable. In various embodiments, the system 101 may be configured to extract the road object value associated with the road object 307, based on the second plurality of road object observations 319. Further, the system 101 may be configured to associate the extracted road object value to the identified link offset. In various embodiments, the system 101 may be configured to update the map database 105a, based on the identified link offset. In some example embodiments, the system 101 may update the map database 105a with the identified link offset and its associated road object value as an attribute of the road object 307 or other feature, such as a road segment, node, POI, or other geographic data record. Further, the updated map database 105a may be used to provide one or more navigation functions.

Further, in some embodiments, the system 101 may be configured to provide the one or more navigation functions for the vehicles such as the vehicle 301a and 301b, based on the identified link offset. For instance, the system 101 may be configured to provide the one or more navigation functions, when the vehicles 301a and/or 301b enter the road segment portion 329 and/or the road segment portion 331. In some example embodiments, when the road object 307 correspond to the speed limit sign and the vehicle 301a and the vehicle 301b have entered the identified link offset, the system 101 may generate control signals for the vehicles 301a and/or 301b travelling on the first 303 to provide at least one lane of the first link 303 for vehicles travelling on second link 309 to smoothly merge into the first link 303 such that traffic congestions, accidents, increased travel time and the like are avoided. To that end, the vehicles 301a and 301b travelling on the first link 303 gets sufficient time to provide at least one lane of the first link 303 for the vehicles travelling on second link 309 before reaching the merging location 317. Further, the system 101 may generate the control signals to control speed values associated with the vehicles 301a and/or the vehicle 301b travelling on the first link 303 and speed values associated with one or more vehicle travelling on the second link 309, when the vehicles 301a and/or the vehicle 301b have entered the road segment portion 329 and the one or more vehicles have entered the road segment portion 331. For instance, the system 101 may reduce or deaccelerate the speed values associated with the vehicles 301a and 301b travelling on the first link 303 as soon as the vehicles 301a and 301b have entered the road segment portion 329, if the vehicles 301a and 301b are travelling at greater speed values than the speed limit value observed on the road object 307; and accelerate speed values associated with the one or more vehicles travelling on the second link 309 as soon as the one or more vehicles have entered the road segment portion 331, if the one or more vehicles travelling on the second link 309 are travelling at lower speed values than the speed limit value observed on the road object 307. To that end, the vehicles 301a and 301b travelling on the first link 303 may get sufficient time to deaccelerate before reaching the merging location 317 and the one or more vehicles travelling on the second link 309 may get sufficient time to accelerate before reaching the merging location 317. Accordingly, the system 101 may provide the one or more navigation functions to the vehicles travelling on the first link 303 and to the vehicles travelling on the second 309 before reaching the merging location 317, such that the traffic congestions, the accidents, the increased travel time and the like are avoided.

Some other non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like. According to some embodiments, if there exists a road object that corresponds to a ramp link and the road object corresponding to the ramp link is located within a second threshold distance from the merging location 317, then the road object observations associated with the road object (that corresponds to the ramp link) may affect the identification of the link offset.

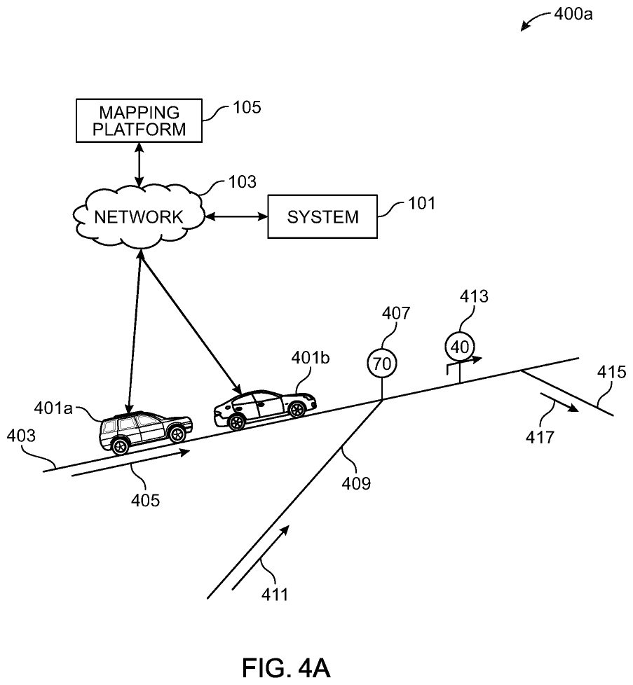

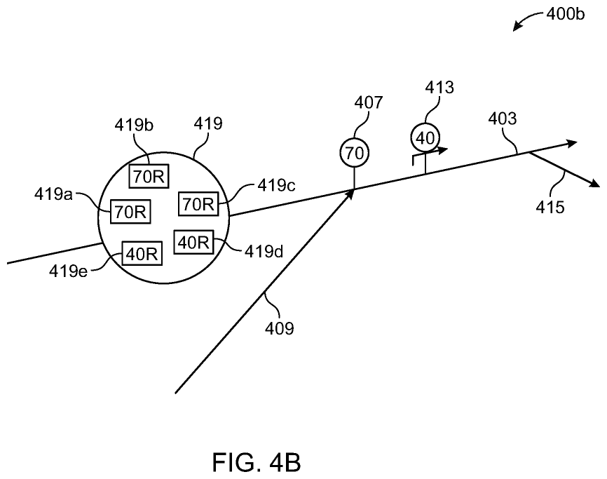

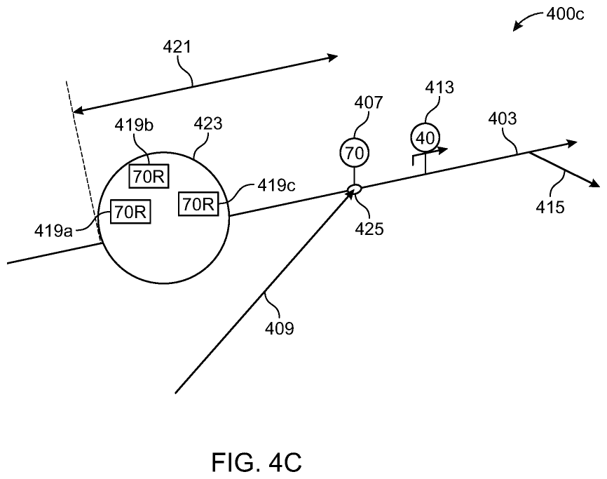

FIG. 4A illustrates a schematic diagram 400a of an exemplary working environment of the system 101 for identifying a link offset in merging links and ramp links road geometry, in accordance with one or more example embodiments. As illustrated in FIG. 4A, the schematic diagram 400a may comprise the system 101, the network 103, the mapping platform 105, a vehicle 401a, a vehicle 401b, a first link 403, a travel direction 405 associated with the first link 403, a road object 407, a second link 409 associated with the first link 403, a travel direction 411 associated with the second link 409, a road object 413, a third link 415 associated with the first link 403, and a travel direction 417 associated with the third link 415. The vehicles 401a and 401b may be the vehicles 301a and 301b explained in the detailed description of FIGS. 3A-3D. The first link 403 and the second link 409 may be the first link 303 and the second link 309 respectively explained in the detailed description of FIGS. 3A-3D. The travel direction 405 and the travel direction 411 may be the travel direction 305 and the travel direction 311 respectively explained in the detailed description of FIGS. 3A-3D. The road object 407 may be the road object 307 explained in the detailed description of FIGS. 3A-3D. As exemplarily illustrated in FIG. 4A, the road object 413 may be located within the second threshold distance from the merging location of the first link 403 and the second link 409. In various embodiments, the second threshold distance may be a predetermined distance. For instance, the second threshold distance may be hundred meter. In some example embodiments, the second threshold distance may be determined based on experimentation and the like. In various embodiments, the road object 413 may comprise at least one of the road sign, the road obstacle, the traffic object, and the like. Further, in some embodiments, the road object 413 may be associated with a direction symbol as illustrated in FIG. 4A. In some example embodiments, the direction symbol associated with the road object 413 may indicate that the road object 413 does not correspond to the first link 403. In other words, the direction symbol associated with the road object 413 may indicate that the road object 413 corresponds to the third link 415. In various embodiments, the third link 415 may be a road segment between two nodes or two intersections. In various embodiments, the third link 415 may be a link parallel to the first link 403 and diverging from the first link 403. In other words, the third link 415 may be the link whose travel direction 417 is similar to the travel direction 405 associated with the first link 403 and the travel direction 417 is diverging from the first link 403. To that end, the third link 415 may be referred as a ramp link associated with the first link 403. As used herein, the travel direction 417 may refer to a direction of travel of vehicles such as the vehicle 401a and/or 401b on the third link 415.

As explained previously in FIG. 3A, the sensors of the vehicles 401a and 401b may be configured to collect the road object observations for the road objects located within a threshold distance from locations of the vehicles 401a and 401b. To that end, the sensors may wrongly collect the road object observations associated with the road object 413 (that corresponds to the third link 415) as the road object observations for the first link 403, if the road object 413 is located within the threshold distance and if the sensors fail to record the direction symbol associated with the road object 413. Accordingly, the road object observations collected by the sensors of the vehicles 401a and 401b for the first link 403 may not be accurate. Further, the road object 407 may be applicable for both the first link 403 and the second link 409 as explained in the detailed description of FIG. 3A. To that end, the system 101 may be configured to remove, using a ramp link criteria, the road object observations associated with the road object 413 from the road object observations received from the sensors of the vehicles 401a and 401b and identify a road segment portion of the first link 403 and a road segment portion of the second link 409 as a link offset for the road object 407 located at the merging location. Accordingly, the system 101 may be configured to receive, from the sensors of the vehicles 401a and the vehicle 401b, a first plurality of road object observations associated with the road object 407 and the road object 413 for the first link 303. Further, the first plurality of road object observations received from the sensor of the vehicles 401a and 401b may be as explained in the detailed description of FIG. 4B.

FIG. 4B illustrates a schematic diagram 400b for receiving an exemplary first plurality of road object observations 419, in accordance with one or more example embodiments. In various embodiments, the system 101 may be configured to receive the first plurality of road object observations 419 associated with the road object 407 and the road object 413 for the first link 303. For instance, the first plurality of road object observations reception module 201a may be configured to receive the first plurality of road object observations 419 associated with the road object 407 and the road object 413 for the first link 403. As illustrated in FIG. 4B, the first plurality of road object observations 419 may comprise road object observations 419a, 419b, and 419c associated with the road object 407 and road object observations 419d and 419e associated with the road object 413. Each of the first plurality of road object observations 419 may comprise a location at where the corresponding road object observation was made and road object information of the corresponding road object as explained in the detailed description of FIG. 3B. Additionally, each of the first plurality of road object observations 419 may comprise timestamp data as explained in the detailed description of FIG. 3B. Further, the system 101 may determine a second plurality of road object observations from the first plurality of road object observations 419 as explained in the detailed description of FIG. 4C.

FIG. 4C illustrates a schematic diagram 400c for determining a second plurality of road object observations 423 from the first plurality of road object observations 419, in accordance with one or more example embodiments. In various embodiments, the system 101 may be configured to determine the second plurality of road object observations 423 from the first plurality of road object observations 419. For instance, the second plurality of road object observations determination module 201b may be configured to determine the second plurality of road object observations 423 from the first plurality of road object observations 419.

Once the first plurality of road object observations 419 are received by the system 101, in various embodiments, the system 101 may be configured to determine whether the second link 409 is merging into the first link 403 within a first threshold distance 421 from the location associated with each of the first plurality of road object observations 419. For instance, the system 101 may determine whether the second link 409 is merging into the first link 403 within the first threshold distance 421 from the locations of the road object observations 419a, 419b, 419c, 419d, and 419e. In various embodiments, the first threshold distance 421 may be a predetermined distance. In some example embodiments, the first threshold distance 421 may be hundred meter. In some example embodiments, the first threshold distance 421 may be determined based on experimentation and the like. In some embodiments, the system 101 may be configured to terminate the process of identifying the link offset, in response to determining the second link 409 is not merging into the first link 403 within the first threshold 421 from each of the first plurality of road object observations 419 (i.e. the location associated with each of the first plurality of road object observations 419).

In various embodiments, the system 101 may be configured to determine a heading data associated with the first link 403 and a heading data associated with the second link 409, in response to determining the second link 409 is merging into the first link 403 within the first threshold 421 from the location associated with at least one of the first plurality of road object observations 419. As used herein, the heading data may be an angle measured in degree or its equivalent from a north direction, a line-of-sight direction, or the like in clockwise direction. In some example embodiments, the system 101 may determine the heading data associated with the first link 403 and the heading data associated with the second link 409 using the map database 105a.

In various embodiments, the system 101 may be configured to determine a heading difference data between the heading data associated with the first link 403 and the heading data associated with the second link 409. For instance, the system 101 may subtract the heading data associated with the first link 403 from the heading data associated with the second link 409 or the heading data associated with the second link 409 from the heading data associated with the first link 403 to determine the heading difference data.

In various embodiments, the system 101 may be configured to determine whether the heading difference data between the heading data associated with the first link 403 and the heading data associated with the second link 409 is less than a threshold heading difference data. In various embodiments, the threshold heading difference data may be a predetermined heading difference data. For instance, the threshold heading difference data may be forty degree or its equivalent. In some example embodiments, the threshold heading difference data may be determined based on experimentation and the like. In some embodiments, the system 101 may be configured to terminate the process of identifying the link offset for the road object 407, in response to determining the heading difference data between the heading data associated with the first link 403 and the heading data associated with the second link 409 is not less than the threshold heading difference data.

In various embodiments, the system 101 may be configured to determine a merging location 425 for the first link 403 and the second link 409, in response to determining the second link 409 is merging into the first link 403 within the first threshold distance 421 from the location associated with at least one of the first plurality of road object observations 419 and the heading difference data between the heading data associated with the first link 403 and the heading data associated with the second link 409 is less than the threshold heading difference data. In some example embodiments, the system 101 may determine, using the map database 105a, a location where the first link 403 and the second link 409 are merging as the merging location 425.

In various embodiments, the system 101 may be configured to determine whether a location associated with the road object 407 and a location associated with the road object 413 are within the second threshold distance from the merging location 425. For instance, the system 101 may perform an upstream search and a downstream search from the merging location 425 to determine whether the location associated with the road object 407 and the location associated with the road object 413 are within the second threshold distance. In some embodiments, the system 101 may be configured to terminate the process of removing the road object observations 419d and 419e associated with the road object 413 from the first plurality of road object observations 419, in response to determining the location associated with the road object 407 and the location associated with the road object 413 are not within the second threshold distance from the merging location 425.

In various embodiments, the system 101 may be configured to determine whether the third link 415 exists within a third threshold distance from the location associated with the road object 407 and from the location associated with the road object 413, in response to determining the location associated with the road object 407 and the location associated with the road object 413 are within the second threshold distance from the merging location 425. In some embodiments, the system 101 may be configured to terminate the process of removing the road object observations 419d and 419e associated with the road object 413, in response to determining the third link 415 does not exist within the third threshold distance from the location associated with the road object 407 and from the location associated with the road object 413. In other words, the system 101 may terminate the process of removing the road object observations 419d and 419e associated with the road object 413, in response to determining that the ramp link criteria are not satisfied. In some embodiments, the ramp link criteria may include conditions such as to determine whether the location associated with the road object 407 and the location associated with the road object 413 are within the second threshold distance from the merging location 425; and to determine whether the third link 415 exists within the third threshold distance from the location associated with the road object 407 and from the location associated with the road object 413. According to some embodiments, the road object 413 may be located at a closer distance from the start location of the third link 415, when compared to the road object 407 as exemplarily illustrated in FIG. 4C. To that end, the system 101 may determine that the third link 415 exists within the third threshold distance from the location associated with the road object 413. In various embodiments, the third threshold distance may be a predetermined distance. In some example embodiments, the third threshold distance may be determined based on experimentation and the like. As used herein, the start location of the third link 415 may indicate a location where the third link 415 starts diverging from the first link 403.

In various embodiments, the system 101 may be configured to determine a third plurality of road observations from the first plurality of road object observations 419, in response to determining the location associated with the road object 407 and the location associated with the road object 413 are within the second threshold distance from the merging location 425 and the third link 415 exists within the third threshold distance from the location associated with the road object 413. In various embodiments, the system 101 may determine the road object observations 419d and 419e associated with the road object 413 as the third plurality of road object observations, because the third link 415 exists within the third threshold distance from the location associated with the road object 413. To that end, the third plurality of road object observations may comprise the road object observations 419d and 419e associated with the road object 413 of the first plurality of road object observations 419.

In various embodiments, the system 101 may be configured to remove the third plurality of road object observations from the first plurality of road object observations 419 to determine the second plurality of road object observations 423. For instance, the system 101 may remove the road object observations 419d and 419e associated with the road object 413 from the first plurality of road object observations 419. Further, the system 101 may be configured to determine the second plurality of road object observations 423 from the first plurality of road object observations 419 after removing the third plurality road object observations from the first plurality of road object observations 419 such that the second plurality of road object observations 423 are within the first threshold distance 421 from the merging location 425. To that end, the second plurality of road object observations 423 may comprise the road object observations 419a, 419b, and 419c associated with the road object 407, if the road object observations 419a, 419b, and 419c are within the first threshold distance 421 from the merging location 425. In some example embodiments, the system 101 may process the road object observations 419d and 419e (i.e. the third plurality of road object observations) using a ramp link algorithm. As used herein, the ramp link algorithm may be an algorithm for identifying the road object 413 for the ramp link (i.e. the third link). To that end, the system 101 may be configured to transmit the third plurality of road object observations to a ramp processing algorithm component for further processing. In various embodiments, the ramp processing algorithm component may comprise ramp link algorithm and may be located within the system 101.

In various embodiments, the system 101 may be further configured to determine the offset distance for each of the second plurality of road object observations 425 as explained in the detailed description of FIG. 3C. In various embodiments, the system 101 may be configured to identify the road segment portion of the first link 403 and the road segment portion of the second link 409 as the link offset, based on the offset distance for each of the second plurality of road object observations 425 as explained detailed description of FIG. 3D. In various embodiments, the system 101 may be configured to update the map database 105a, based on the identified link offset.

Further, in some embodiments, the system 101 may be configured to provide the one or more navigation functions for the vehicles travelling on the first link 403 and the vehicles travelling on the second link 409 as explained in the detailed description of FIG. 3D. According to some embodiments, if there exists a fourth link (for instance, a link parallel to the first link 403) on a same side where the second link 409 exists and if the fourth link comprises one or more road objects, then road object observations of the one or more road objects that correspond to the fourth link may affect the identification of the link offset.

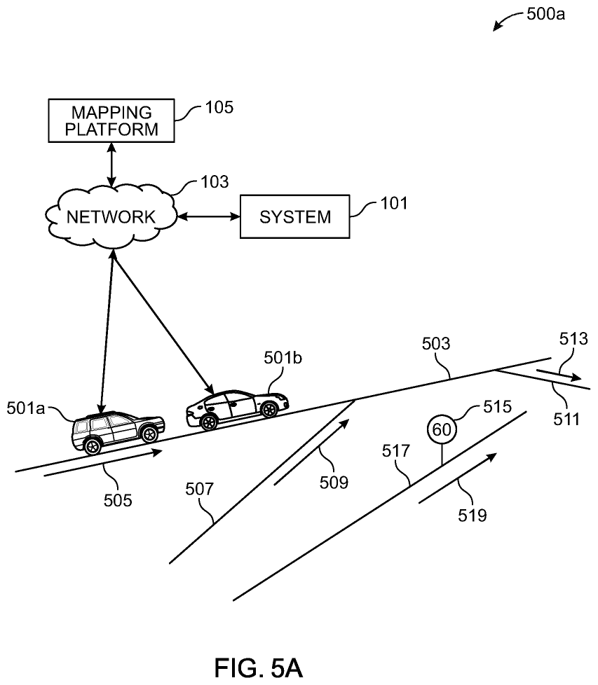

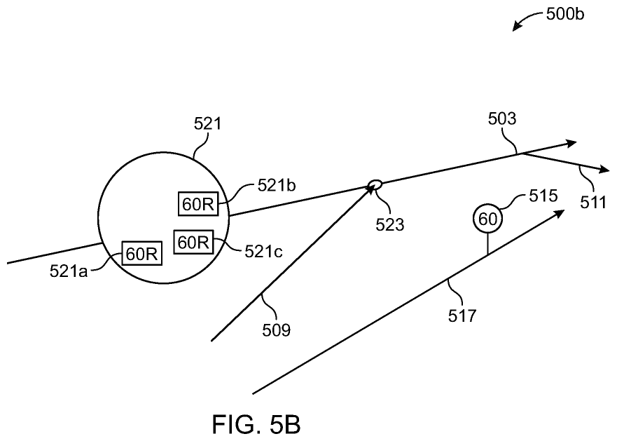

FIG. 5A illustrates a schematic diagram 500a of an exemplary working environment of the system 101 in merging links and parallel links road geometry, in accordance with one or more example embodiments. As illustrated in FIG. 5A, the schematic diagram 500a may comprise the system 101, the network 103, the mapping platform 105, a vehicle 501a, a vehicle 501b, a first link 503, a travel direction 505 associated with the first link 503, a second link 507 associated with the first link 503, a travel direction 509 associated with the second link 507, a third link 511 associated with the first link 503, a travel direction 513 associated with the third link 511, a road object 515, a fourth link 517 is a link parallel to the first link 503, and a travel direction 519 associated with the fourth link 517. The vehicles 501a and 501b may be the vehicles 301a and 301b explained in the detailed description of FIGS. 3A-3D. The first link 503 and the second link 507 may be the first link 303 and the second link 309 respectively explained in the detailed description of FIGS. 3A-3D. The travel direction 505 and the travel direction 509 may be the travel direction 305 and the travel direction 311 respectively explained in the detailed description of FIGS. 3A-3D. The third link 511 and the travel direction 513 may be the third link 415 and the travel direction 417 respectively explained in the detailed description of FIGS. 4A-4C. As exemplarily illustrated in FIG. 5A, the road object 515 may be located on a link (i.e. the fourth link 517) parallel to the first link 503. In various embodiments, the road object 515 may comprise at least one of the road sign, the road obstacle, the traffic object, and the like as explained in the detailed description of FIG. 3A. In various embodiments, the fourth link 517 may be a road segment between two nodes or two intersections. In various embodiments, the fourth link 517 may be a link parallel to the first link 503. Further, the fourth link 517 neither diverges from the first link 503 nor merges into the first link 503. In other words, the fourth link 517 may be the link whose travel direction 519 is similar to the travel direction 505 associated with the first link 503 and the travel direction 519 neither diverges from the first link 503 nor merges into the first link 503. To that end, the fourth link 517 may be referred as a parallel link to the first link 503. As used herein, the travel direction 519 may refer to a direction of travel of vehicles on the fourth link 513.

As explained previously in FIG. 3A, the sensors of the vehicles 501a and 501b may be configured to collect the road object observations for the road objects located within a threshold distance from locations of the vehicles 501a and 501b. To that end, the sensors may wrongly collect the road object observations associated with the road object 515 (that corresponds to the fourth link 517) as the road object observations for the first link 503, if the road object 515 is located within the threshold distance. Accordingly, the road object observations collected by the sensors of the vehicles 501a and 501b for the first link 503 may not be accurate. To that end, the system 101 may be configured to determine the road object observations associated with the road object 515 and proceed with a parallel link algorithm for identifying whether the road object 515 is associated with the first link 503 or is associated with the fourth link 517. As used herein, the parallel link algorithm may be an algorithm for identifying the road object 515 for the parallel links such as the first link 503 and the fourth link 517. Accordingly, the system 101 may be configured to receive, from the sensors of the vehicles 501a and the vehicle 501b, a first plurality of road object observations associated with the road object 515 for the first link 503. Further, the first plurality of road object observations received from the sensor of the vehicles 501a and 501b may be as explained in the detailed description of FIG. 5B.

FIG. 5B illustrates a schematic diagram 500b for receiving an exemplary first plurality of road object observations 521, in accordance with one or more example embodiments. In various embodiments, the system 101 may be configured to receive the first plurality of road object observations 521 associated with the road object 515 for the first link 503. For instance, the first plurality of road object observations reception module 201a may be configured to receive the first plurality of road object observations 521 associated with the road object 515 for the first link 503. As illustrated in FIG. 5B, the first plurality of road object observations 521 may comprise road object observations 521a, 521b, and 521c associated with the road object 515. Each of the first plurality of road object observations 521 may comprise a location at where the corresponding road object observation was made and road object information of the corresponding road object as explained in the detailed description of FIG. 3B. Additionally, each of the first plurality of road object observations 521 may comprise timestamp data as explained in the detailed description of FIG. 3B.

Once the first plurality of road object observations 521 are received by the system 101, in various embodiments, the system 101 may be configured to determine a merging location 523 for the first link 503 and the second link 509 as explained in the detailed description of FIG. 3A. For instance, the system 101 may determine whether the second link 509 is merging into the first link 503 within the first threshold distance 319 from the location associated with each of the first plurality of road object observations 521; determine whether a heading difference data between a heading data associated with the first link 503 and a heading data associated with the second link 509 is less than the threshold heading difference data; and determine the merging location 523 for the first link 503 and the second link 509, in response to determining the second link 509 is merging into the first link 503 within the first threshold distance 319 from the location associated with at least one of the first plurality of road object observations 521 and the heading difference data between the heading data associated with the first link 503 and the heading data associated with the second link 509 is less than the threshold heading difference data. As used herein, the heading data may be an angle measured in degree or its equivalent from a north direction, a line-of-sight direction, or the like in clockwise direction.

In various embodiments, the system 101 may be configured to determine whether the fourth link 517 and the second link 509 exist on the same side for each of the first plurality of road object observations 521. For instance, the system 101 may determine whether the fourth link 517 and the second link 509 exist on a same side for each of the road object observations 521a, 521b, and 521c. In other words, the system 101 may be configured to execute a parallel link criteria. In some embodiments, the parallel link criteria may be a condition to determine whether the fourth link 517 and the second link 509 exist on the same side for each of the first plurality of road object observations 521. In some embodiments, the system 101 may be configured to terminate the process of proceeding with the parallel link algorithm, in response to determining the fourth link 517 and the second link 509 do not exist on a same side for each of the plurality of road object observations 521. In some example embodiments, the system 101 may configured to terminate the process of removing the road object observations 521a, 521b, and 521c associated with the road object 515 from the first plurality of road object observations 521, in response to determining the fourth link 517 and the second link 509 do not exist on a same side for each of the plurality of road object observations 521.

In some example embodiments, the system 101 may determine, using the map database 105a, whether the fourth link 517 exists within a threshold distance from the location associated with each of the first plurality of road object observations 521; and determine, using the map database 105a and the road object observations 521a, 521b, and 521c whether the fourth link 517 and the second link 509 exist on a same side. As the fourth link 517 and the second link 509 exists on a right side for each of the road object observations 521a, 521b, and 521c, the system 101 may determine that the fourth link 517 and the second link 509 exist on a same side for each of the road object observations 521a, 521b, and 521c associated with the road object 515. As used herein, the right side for a road object observation may be determined relative to a direction associated with the road object observation. Further, the direction associated with the road object observation may be determined by the heading data associated with the road object observation. In various embodiments, the heading data associated with the road object observation may be determined from map database 105a.

In various embodiments, the system 101 may be configured to determine a fourth plurality of road object observations from the first plurality of road object observations 521, in response to determining the fourth link 517 and the second link 509 exist on the same side for each of the first plurality of road object observations 521. In various embodiments, the fourth plurality of road object observations may comprise the road object observations 521a, 521b, and 521c associated with the road object 515.

In various embodiments, the system 101 may be configured to remove the fourth plurality of road object observations from the first plurality of road object observations 521 to determine the second plurality of road object observations. To that end, the second plurality of road object observations may be a null set or an empty set. Accordingly, the system 101 may be configured to proceed with the parallel link algorithm to identify whether the road object 515 is associated with the first link 503 or is associated with the fourth link 517.

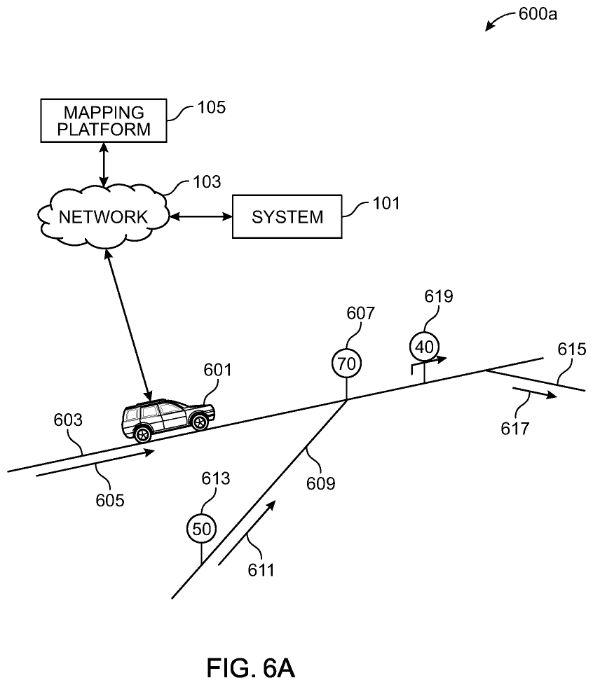

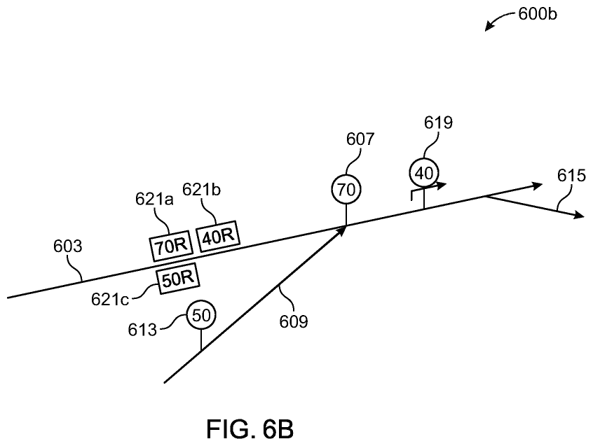

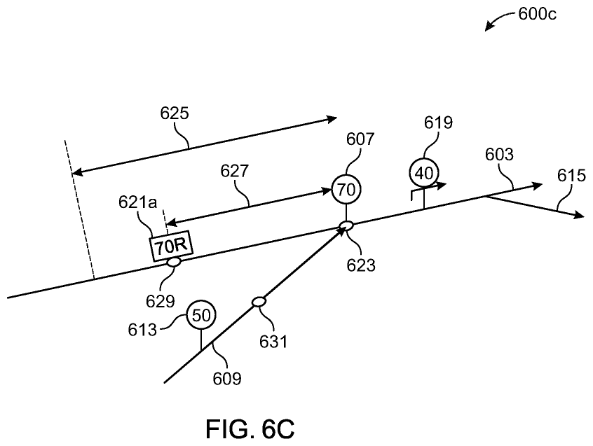

FIG. 6A illustrates a schematic diagram 600a of an exemplary working environment of the system 101 for a real-time link offset identification in a complex road geometry, in accordance with one or more example embodiments. As illustrated in FIG. 6A, the schematic diagram 600a may comprise the system 101, the network 103, the mapping platform 105, a vehicle 601, a first link 603, a travel direction 605 associated with the first link 603, a road object 607, a second link 609 associated with the first link 603, a travel direction 611 associated with the second link 609, a road object 613, a third link 615 associated with the first link 603, and a travel direction 617 associated with the third link 615, and a road object 619. The vehicle 601 may be at least one of the vehicle 301a or the vehicle 301b explained in the detailed description of FIGS. 3A-3D. The first link 603 and the second link 609 may be the first link 303 and the second link 309 respectively explained in the detailed description of FIGS. 3A-3D. The travel direction 605 and the travel direction 611 may be the travel direction 305 and the travel direction 311 respectively explained in the detailed description of FIGS. 3A-3D. The road object 607 may be the road object 307 explained in the detailed description of FIGS. 3A-3D. The third link 615 and the travel direction 617 associated with the third link 615 may be the third link 415 and the travel direction 417 associated with the third link 415 respectively explained in the detailed description of FIG. 4A. The road object 619 may be the road object 413 explained in the detailed description of FIG. 4A.

As explained previously in FIG. 3A, the sensors of the vehicles 601 may be configured to collect the road object observations for the road objects located within a threshold distance from a location of the vehicle 601. To that end, the sensors may wrongly collect the road object observations associated with the road object 613 and the road object 619 as the road object observations for the first link 603, if the road object 613 and the road object 619 are located within the threshold distance from the location of the vehicle 601. Accordingly, the road object observations collected by the sensors of the vehicle 601 for the first link 603 may not be accurate. Further, the road object 607 may be applicable for both the first link 603 and the second link 609 as explained in the detailed description of FIG. 3A. To that end, the system 101 may be configured to remove the road object observations associated with the road object 613 and the road object 619 and further configured to identify a road segment portion of the first link 603 and a road segment portion of the second link 609 as the link offset for the road object 607. Accordingly, the system 101 may be configured to receive, from the sensors of the vehicle 601, a first plurality of road object observations associated with the road object 607, the road object 613, and the road object 619 for the first link 603. Further, the first plurality of road object observations received from the sensor of the vehicle 601 may be as explained in the detailed description of FIG. 6B.

FIG. 6B illustrates a schematic diagram 600b for receiving an exemplary first plurality of road object observations 621a, 621b, and 621c, in accordance with one or more example embodiments. In various embodiments, the system 101 may be configured to receive the first plurality of road object observations 621a, 621b, and 621c associated with the road object 607, the road object 619, and the road object 613, respectively, for the first link 603. For instance, the first plurality of road object observations reception module 201a may be configured to receive the first plurality of road object observations 621a, 621b, and 621c associated with the road object 607, the road object 619, and the road object 613 respectively for the first link 603. In various embodiments, the first plurality of road object observations 621a, 621b, and 621c may comprise a road object observation 621a associated with the road object 607, a road object 621b associated with the road object 619, and a road object observation 621c associated with the road object 613. In various embodiments, each of the first plurality of road object observations 621a, 621b, and 621c may comprise a location where the corresponding road object observation was made and road object information of the corresponding road object as explained in the detailed description of FIG. 3B. Additionally, each of the first plurality of road object observations 621a, 621b, and 621c may comprise the timestamp as explained in the detailed description of FIG. 3B. Further, the system 101 may determine a second road object observation from the first plurality of road object observations 621a, 621b, and 621c, based on a filtering criteria as explained in the detailed description of FIG. 6C. In various embodiments, the filtering criteria may comprise one or more of the merging link criteria, the merging heading difference criteria, the ramp link criteria, and the parallel link criteria.

FIG. 6C illustrates a schematic diagram 600c for determining a second road object observation 621a from the first plurality of road object observations 621a, 621b, and 621c, in accordance with one or more example embodiments. In various embodiments, the system 101 may be configured to determine the second road object observation 621a from the first plurality of road object observations 621a, 621b, and 621c, based on the filtering criteria. For instance, the second plurality of road object observations determination module 201b may be configured to determine the second road object observation 621a from the first plurality of road object observations 621a, 621b, and 621c, based on a filtering criteria.

Once the first plurality of road object observations 621a, 621b, and 621c are received by the system 101, in various embodiments, the system 101 may be configured to determine a merging location 623 for the first link 603 and the second link 609 as explained in the detailed description of FIG. 3A. For instance, the system 101 may determine whether the second link 609 is merging into the first link 603 within a first threshold distance 625 from the location associated with each of the first plurality of road object observations 621a, 621b, and 621c (i.e. the system 101 may execute the merging link criteria); determine whether a heading difference data between a heading data associated with the first link 603 and a heading data associated with the second link 609 is less than the threshold heading difference data (i.e. the system 101 may execute the merging heading difference criteria); and determine the merging location 623 for the first link 603 and the second link 609, in response to determining the second link 609 is merging into the first link 503 within the first threshold distance 625 from the location associated with at least one of the first plurality of road object observations 621a, 621b, and 621c and the heading difference data between the heading data associated with the first link 603 and the heading data associated with the second link 609 is less than the threshold heading difference data. As used herein, the first threshold distance 625 may be the first threshold distance 319 explained in the detailed description of FIG. 3C. As used herein, the heading data may be an angle measured in degree or its equivalent from a north direction, a line-of-sight direction, or the like in clockwise direction.

Further, in various embodiments, the system 101 may execute the ramp link criteria. In various embodiments, the system 101 determine the road object observation 621b associated with the road object 619 as a third road object observation after executing the ramp link criteria. For instance, the system 101 determine the road object observation 621b associated with the road object 619 as a third road object observation, in response to determining that the road object 619 is within the second threshold distance from the merging location 623; and the third link 615 exists within the third threshold distance from the location associated with the road object 619 as explained in the detailed description of FIG. 4C. Further, the system 101 may be configured to remove the third road object observation (i.e. the road object observation 621b) from the first plurality of road object observations 621a, 621b, and 621c.

To that end, the first plurality of road object observations may comprise the road object observations 621a associated with the road object 607 and the road object observation 621c associated with the road object 613 after removing the road object observation 621b.

Further, in some embodiments, the system 101 may be configured to execute the parallel link criteria. For instance, the system 101 may determine whether a fourth link exists on the same side where the second link 609 exists for each of the road object observation 621a and the road object observation 621c. In some embodiments, the system 101 may terminate the process proceed to parallel link algorithm, in response to determining the fourth link does not exists on the same side where the second link 609 exists for each of the road object observation 621a and the road object observation 621c.

In various embodiments, the system 101 may be configured to determine the road object observation 621a associated with the road object 607 as the second road object observation, in response removing the road object observation 621c associated with the road object 613 based on the first distance criteria and the road object value criteria as explained in the detailed description of FIG. 3C.

In various embodiments, the system 101 may be configured to determine an offset distance 627 for the second road object observation (i.e. the road object observation 621a). In various embodiments, the system 101 may determine a distance from the location associated with the second road object observation to the merging location 623 as the offset distance 627.

In various embodiments, the system 101 may be configured determine a first offset location 629 on the first link 603 as explained in the detailed description of FIG. 3D. In various embodiments, the system 101 may determine a location on the first link 603 as the first offset location 629, if the location on the first link 603 is located at the distance equivalent to the offset distance 627 from the location associated with the road object 607 or from the merging location 623. To that end, in some example embodiments, the first offset location 629 may be the location associated with the road object observation 621a.

In various embodiments, the system 101 may be configured determine a second offset location 631 on the second link 609 as explained in the detailed description of FIG. 3D. In various embodiments, the system 101 may determine a location on the second link 609 as the second offset location 631, if the location on the second link 609 is located at the distance equivalent to the offset distance 627 from the location associated with the road object 607 or from the merging location 623.

In various embodiments, the system 101 may be configured to identify a road segment portion of the first link 603 from the first offset location 629 to the merging location 623 (i.e. the location associated with the road object 607) and a road segment portion of the second link 609 from the second offset location 631 to the merging location 623 (i.e. the location associated with the road object 607) as the link offset for the road object 607. In various embodiments, the system 101 may be configured to update the map database 105a, based on the identified link offset.

Further, in some embodiments, the system 101 may be configured to provide the one or more navigation functions for the vehicle 601, based on the identified link offset. For instance, the system 101 may generate the control signals for the vehicle 601 to deaccelerate speed value associated with the vehicle 601, if the speed value associated with the vehicle 601 is more than the speed limit value observed in the road object 607, and further may generate the control signals for the vehicle 601 to provide at least one lane of the first link 603 for one or more vehicles travelling on the second link 609 to smoothly merge into the first link 603 such that the traffic congestions, the accidents, the increased travel time and the like are avoided. To that end, the vehicle 601 gets sufficient time to provide at least one lane of the first link 603 for the one or more vehicles travelling on the second link 609 to smoothly merge into the first link 603 and to deaccelerate or reduce the speed value associated with the vehicle 601, if the speed value associated with the vehicle 601 is more than the speed limit value observed in the road object 607.

Some other non-limiting examples of the navigation functions provided by the system 101 may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

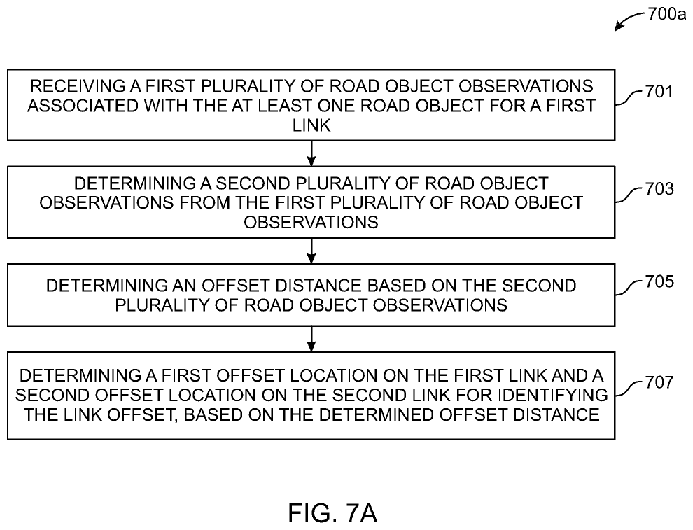

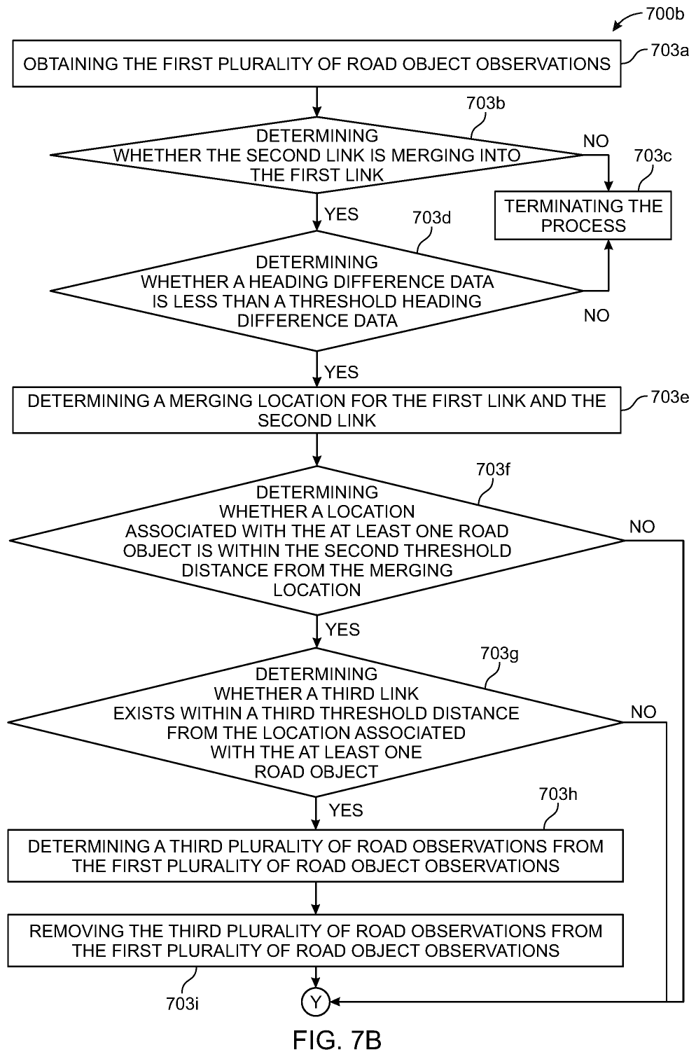

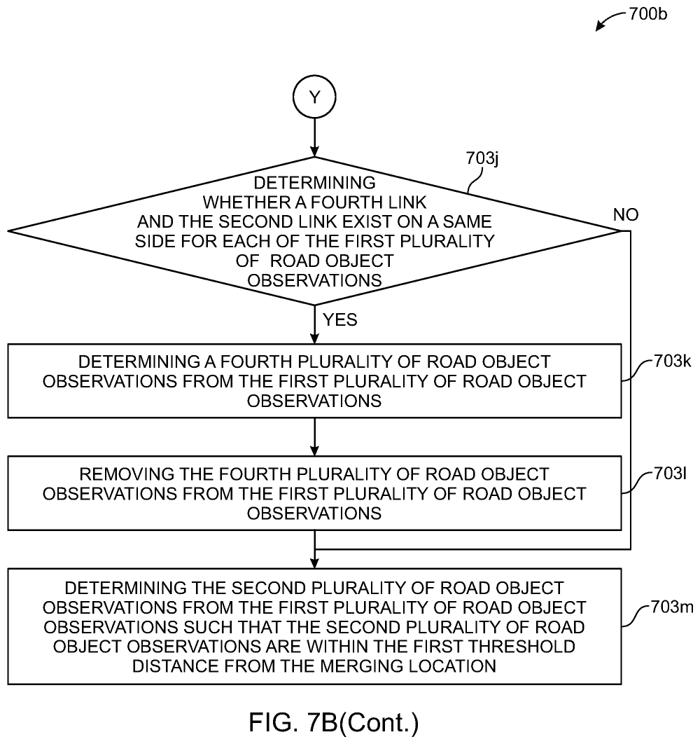

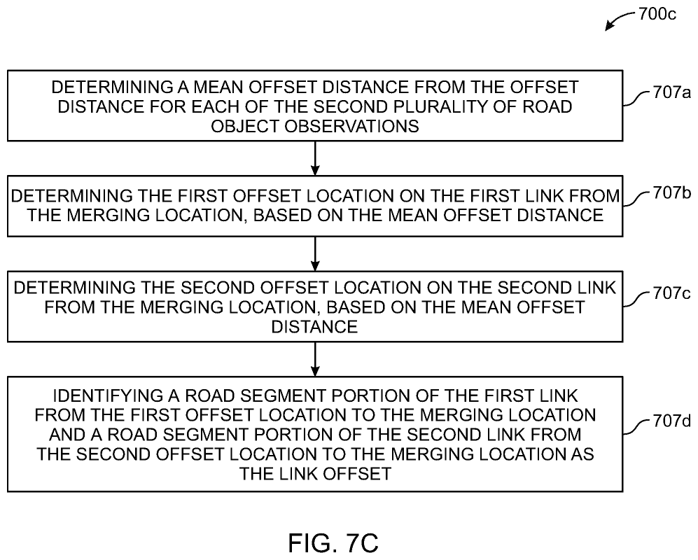

FIG. 7A illustrates a flowchart depicting a method 700a for identifying a link offset, in accordance with one or more example embodiments. It will be understood that each block of the flow diagram of the method 700a may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 701, the method 700a may comprise receiving the first plurality of road object observations 315 associated with at least one of the road object 307 and the road object 313 for the first link 303. For instance, the first plurality of road object observations reception module 201a may be configured to receive the first plurality of road object observations 315 associated with the road object 307 and the road object 313 for the first link 303. In various embodiments, the first link 303 may be a link parallel to the second link 309. In various embodiments, the second link 309 may be a link parallel to the first link 303 and merging into the first link 303. In various embodiments, the first plurality of road object observations 315 may comprise the road object observations 315a, 315b, and 315c associated with the road object 307 and the road object observations 315d and 315e associated with the road object 313. In various embodiments, each of the road objects 307 and the road object 313 may comprise at least one of the road sign, the traffic object, or the road obstacle.

At block 703, the method 700a may comprise determining the second plurality of road object observations 321 from the first plurality of road object observations 315. For instance, the second plurality of road object observations determination module 201b may be configured to determine the second plurality of road object observations 321 from the first plurality of road object observations 315 as explained in the detailed description of FIG. 3C. Further, at block 703, the method 700a may comprise some additional blocks for determining he second plurality of road object observations 321.

FIG. 7B illustrates a flowchart depicting a method 700b for determining the second plurality of road object observations 321 from the first plurality of road object observations 315, in accordance with one or more example embodiments. The method 700b may be used in conjunction to the system 101 described in the detailed description of FIGS. 3A-3D.

Starting at block 703a, the method 700b may comprise obtaining the first plurality of road object observations 315. For instance, the second plurality of road object observations determination module 201b may obtain the first plurality of road object observations 315 from the first plurality of road object observations reception module 201a.

At block 703b, the method 700b may comprise determining whether the second link 309 is merging into the first link 303 within the first threshold distance 319 from the location associated with each of the first plurality of road object observations 315. In response to determining the second link 309 is not merging into the first link 303 within the first threshold distance 319 from the location associated with each of the first plurality of road object observations 315, the method 700b may continue with block 703c.

At block 703c, the method 700b may comprise terminating the process of identifying the link offset. In response to determining the second link 309 is merging into the first link 303 within the first threshold distance 319 from the location associated with at least one of the first plurality of road object observations 315, the method 700b may continue with block 703d.

At block 703d, the method 700b may comprise determining whether the heading difference data between the heading data associated with the first link 303 and the heading data associated with the second link 309 is less than the threshold heading difference data. In response to determining the heading difference data between the heading data associated with the first link 303 and the heading data associated with the second link 309 is not less than the threshold heading difference data, the method 700b may continue with block 703c.

In response to determining the heading difference data between the heading data associated with the first link 303 and the heading data associated with the second link 309 is less than the threshold heading difference data, the method 700b may continue with block 703e.

At block 703e, the method 700b may comprise determining the merging location 317 for the first link 303 and the second link 309. For instance, the system 101 may determine the merging location 317 for the first link 303 and the second link 309 as explained in the detailed description of FIG. 3C.

At block 703f, the method 700b may comprise determining whether the location associated with the road object 307 and the location associated with the road object 313 are within the second threshold distance from the merging location 317. In response to determining the location associated with the road object 307 and the location associated with the road object 313 are not within the second threshold distance from the merging location 317, the method 700b may continue with block 703j.

In response to determining the location associated with the road object 307 and the location associated with the road object 313 are within the second threshold distance from the merging location 317, the method 700b may continue with block 703g.

At block 703g, the method 700b may comprise determining whether the third link 415 exists within the third threshold distance from the location associated with road object 307 and the location associated with the road object 313. In response to determining the third link 415 does not exists within the third threshold distance from the location associated with road object 307 and the location associated with the road object 313, the method 700b may continue with the block 703j.

In response to determining the third link 415 exists within the third threshold distance from the location associated with at least one of the road object 407 or the road object 413, the method 700b may continue with block 703h.

At block 703h, the method 700b may comprise determining the third plurality of road object observations from the first plurality of road object observations 419. For example, the system 101 may determine the third plurality of road object observations from the first plurality of road object observations 419, if the location associated with the road object 407 and the location associated with the road object 413 are within the second threshold distance from the merging location 425; and if the third link 415 exists within the third threshold distance from the location associated with at least one of the road object 407 or the road object 413 as explained in the detailed description of FIG. 4C.

At block 703i, the method 700b may comprise removing the third plurality of road object observations from the first plurality of road object observations 419 for determining the second plurality of road object observations 423. For instance, the system 101 may remove the third plurality of road object observations from the first plurality of road object observations 419 for determining the second plurality of road object observations 423. In some other embodiments, the system 101 may process the third plurality of road object observations using the ramp link algorithm. As used herein, the ramp link algorithm may be an algorithm for identifying the road object for the third link 415 (i.e. the ramp link).

At block 703j, the method 700b may comprise determining whether the fourth link 517 and the second link 309 exist on a same side for each of the first plurality of road object observations 315. In response to determining the fourth link 517 and the second link 309 do not exist on the same side for each of the first plurality of road object observations 315, the method 700b may continue with block 703m.

In response to determining the fourth link 517 and the second link 509 exist on the same side, the method 700b may continue with block 703k. At block 703k, the method 700b may comprise determining the fourth plurality of road object observations from the first plurality of road object observations 521. For instance, the system 101 may determine the fourth plurality of road object observations from the first plurality of road object observations 521, if the fourth link 517 exists on the side where the second link 509 exists.

At block 7031, the method 700b may comprise removing the fourth plurality of road object observations from the first plurality of road object observations 521 for determining the second plurality of road object observations. For instance, the system 101 may remove the fourth plurality of road object observations from the first plurality of road object observations 521 for determining the second plurality of road object observations. In some other embodiments, the system 101 may process the fourth plurality of road object observations using the parallel link algorithm.

At block 703m, the method 700b may comprise determining the second plurality of road object observations 321 from the first plurality of road object observations 315 such that the second plurality of road object observations 321 are within the first threshold distance 319 from the merging location 317. For instance system 101 may determine the second plurality of road object observations 321 from the first plurality of road object observations 315 such that the second plurality of road object observations 321 are within the first threshold distance 319 from the merging location 317 as explained in the detailed description of FIG. 3C. In some example embodiments, the system 101 may further determine the second plurality of road object observations 321 from the first plurality of road object observations 315, based on the road object value criteria as explained in the detailed description of FIG. 3C.

As should be understood, once the second plurality of road object observations 321 are determined at block 703m, the method 700b may continue with block 705 of the method 700a.

At block 705, the method 700a may comprise determining the offset distance for each of the second plurality of road object observations 321. For instance, the system 101 may determine the offset distance for each of the second plurality of road object observations 321 as explained in the detailed description of FIG. 3D. In various embodiments, the offset distance for the road object observation 315a may be the distance from the location associated with the road object observation 315a to the merging location 317 (i.e. the location associated with the road object 307).

At block 707, the method 700a may comprise identifying the road segment portion 329 of the first link 303 and the road segment portion 331 of the second link 309 as the link offset, based on the offset distance for each of the second plurality of road object observations 321. For instance, the link offset identification module 201d may be configured to identify the road segment portion 329 of the first link 303 and the road segment portion 331 of the second link 309 as the link offset, based on the offset distance for each of the second plurality of road object observations 321 as explained in the detailed description of FIG. 3D. Further, at block 707, the method 700a may comprise some additional blocks for identifying the road segment portion 329 of the first link 303 and the road segment portion 331 of the second link 309 as the link offset.

FIG. 7C illustrates a flowchart depicting a method 700c for identifying the road segment portion 329 of the first link 303 and the road segment portion 331 of the second link 309 as the link offset, in accordance with one or more example embodiments. The method 700c may be used in conjunction to the system 101 described in the detailed description of FIGS. 3A-3D.

Starting at block 707a, the method 700c may comprise determining the mean offset distance 323 from the offset distance for each of the second plurality of road object observations 321. For instance, the system 101 may determine the mean offset distance 323 from the offset distance for each of the second plurality of road object observations 321 as explained in the detailed description of FIG. 3D.

At block 707b, the method 700c may comprise determining the first offset location 325 on the first link 303 from the merging location 317, based on the mean offset distance 323. For instance, the system 101 may determine the first offset location 325 on the first link 303 from the merging location 317, based on the mean offset distance 323 as explained in the detailed description of FIG. 3D.

At block 707c, the method 700c may comprise determining the second offset location 327 on the second link 309 from the merging location 317, based on the mean offset distance 323. For instance, the system 101 may determine the second offset location 327 on the second link 309 from the merging location 317, based on the mean offset distance 323 as explained in the detailed description of FIG. 3D.

At block 707d, the method 700c may comprise identifying the road segment portion 329 of the first link 303 from the first offset location 325 to the merging location 317 and the road segment portion 331 of the second link 309 from the second offset location 327 to the merging location 317 as the link offset. For instance, the system 101 may identify the road segment portion 329 of the first link 303 from the first offset location 325 to the merging location 317 and the road segment portion 331 of the second link 309 from the second offset location 327 to the merging location 317 as the link offset.

Additionally, in some embodiments, the method 700a may comprise updating the map database 105a, based on the identified link offset. In some other embodiments, the method 700a may comprise providing the one or more navigation functions for the vehicles such as the vehicle 301a and 301b, based on the identified link offset. For instance, the system 101 may generate the control signals for the vehicles 301a and 301b travelling on the first link 303 to deaccelerate the speed values associated with the vehicles 301a and 301b as soon as the vehicles 301a and 301b have entered the road segment portion 329, if the speed values associated with the vehicles 301a and 301b are more than the speed limit value observed in the road object 307; and further may generate the control signals for the one or more vehicles travelling on the second link 309 to accelerate the speed values associated with the one or more vehicles as soon as the one or more vehicles have entered the road segment portion 331, if the speed values associated with the one or more vehicles are less than the speed limit value observed in the road object 307. To that end, the vehicles 301a and 301b travelling on the first link 303 may get sufficient time to deaccelerate before reaching the merging location 317 and the one or more vehicles travelling on the second link 309 may get sufficient time to accelerate before reaching the merging location 317. Accordingly, the system 101 may provide the one or more navigation functions to the vehicles travelling on the first link 303 and to the vehicles travelling on the second 309 before reaching the merging location 317, such that the traffic congestions, the accidents, the increased travel time and the like are avoided.

Some other non-limiting examples of the navigation functions provided by the system 101 may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for identifying a link offset, the system comprising:
a memory configured to store computer-executable instructions; and
one or more processors configured to execute the instructions to:
receive a first plurality of road object observations associated with at least one road object for a first link, wherein the first link is associated with a second link;
determine a second plurality of road object observations from the first plurality of road object observations;
determine an offset distance based on the second plurality of road object observations; and
identify a road segment portion of the first link and a road segment portion of the second link as the link offset, based on the determined offset distance.

2. The system of claim 1, wherein to determine the second plurality of road object observations, the one or more processors are further configured to:
determine whether the second link is merging into the first link within a first threshold distance from a location associated with each of the first plurality of road object observations;
determine whether a heading difference data between a heading data associated with the first link and a heading data associated with the second link is less than a threshold heading difference data;
determine a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data; and
determine the second plurality of road object observations from the first plurality of road object observations such that the second plurality of road object observations are within the first threshold distance from the merging location.

3. The system of claim 2, wherein the offset distance is a distance from a location associated with a second road object observation of the second plurality of road object observations to the merging location.

4. The system of claim 2, wherein to identify the road segment portion of the first link and the road segment portion of the second link as the link offset, the one or more processors are further configured to:
determine a mean offset distance from the offset distance for each of the second plurality of road object observations;
determine a first offset location on the first link from the merging location, based on the mean offset distance;
determine a second offset location on the second link from the merging location, based on the mean offset distance; and
identify the road segment portion of the first link from the first offset location to the merging location and the road segment portion of the second link from the second offset location to the merging location as the link offset.

5. The system of claim 1, wherein to determine the second plurality of road object observations, the one or more processors are further configured to:
determine whether the second link is merging into the first link within a first threshold distance from a location associated with each of the first plurality of road object observations;
determine whether a heading difference data between a heading data associated with the first link and a heading data associated with the second link is less than a threshold heading difference data;
determine a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data;
determine whether a location associated with the at least one road object is within the second threshold distance from the merging location;
determine whether a third link exists within a third threshold distance from the location associated with the at least one road object, wherein the third link is a ramp link associated with the first link;
determine a third plurality of road observations from the first plurality of road object observations, in response to determining the location associated with the at least one road object is within the second threshold distance from the merging location and the third link is located within the third threshold distance from the location associated with the at least one road object; and
remove the third plurality of road object observations from the first plurality of road object observations to determine the second plurality of road object observations.

6. The system of claim 1, wherein to determine the second plurality of road object observations, the one or more processors are further configured to:
determine whether a fourth link and the second link exist on a same side for each of the first plurality of road object observations, wherein the fourth link is a link parallel to the first link;
determine a fourth plurality of road object observations from the first plurality of road object observations, in response to determining the fourth link and a second link exist on the same side; and
remove the fourth plurality of road object observations from the first plurality of road object observations to determine the second plurality of road object observations.

7. The system of claim 1, wherein the one or more processors are further configured to update a map database, based on the identified link offset.

8. The system of claim 1, wherein the one or more processors are further configured to provide one or more navigation functions for a vehicle, based on the identified link offset.

9. A computer program product comprising a non-transitory computer readable medium having stored thereon computer executable instruction which when executed by one or more processors, cause the one or more processors to carry out operations for identifying at least one road object, the operations comprising:
receiving a first plurality of road object observations associated with the at least one road object;
determining, based on the received first plurality of road object observations, at least a first link and a second link, wherein the first link is a link associated with the road object and the second link is proximate to the first link;
determining a second plurality of road object observations from the first plurality of road object observations based on a filtering criteria;
determining an offset distance for each of the first link and the second link based on the second plurality of road object observations; and
identifying the at least one road object based on the offset distance, wherein identifying the at least one road object comprises associating the at least one road object with at least one of the first link and the second link based on the offset distance.

10. The computer program product of claim 9, wherein for identifying the at least one road object based on the offset distance, the operations further comprise:
extracting a road object value associated with the at least one road object based on the second plurality of road object observations; and
associating the at least one road object and the extracted road object value with each of the first link and the second link based on the offset distance to identify the at least one road object for each of the first link and the second link; wherein the offset distance is used to determine a portion of segment, for each of the first link and the second link, on which the extracted road object value is applied.

11. The computer program product of claim 9, wherein the filtering criteria comprises one or more of:
a merging link criteria;
a merging heading difference criteria;
a ramp link criteria; and
a parallel link criteria.

12. The computer program product of claim 11, wherein for determining the second plurality of road object observations from the first plurality of road object observations based on the filtering criteria, the operations further comprise:
determining the second plurality of road object observations based on the merging link criteria and the merging heading difference criteria,
wherein the merging link criteria comprises determining that the second link is merging into the first link at a merging location, and wherein a distance between the merging location and a location associated with each road object observation in the second plurality of road object observations is within a first threshold distance; and
wherein the merging heading difference criteria comprises determining that heading difference data between heading data associated with the first link and a heading data associated with the second link is less than a threshold heading difference data.

13. The computer program product of claim 12, wherein for determining the second plurality of road object observations from the first plurality of road object observations based on the filtering criteria, the operations further comprise:
determining the second plurality of road object observations based on the ramp link criteria, wherein the ramp link criteria comprises:
determining whether a location associated with the road object is within a second threshold distance from the merging location;
determining whether a third link exists within a third threshold distance from the location associated with the at least one road object, wherein the third link is a ramp link;
determining a third plurality of road object observations, in response to determining the location associated with the road object is within the second threshold distance from the merging location and the third link is located within a third threshold distance from the location associated with the at least one road object; and
determining the second plurality of road object observations by removing the third plurality of road object observations from the first plurality of road object observations.

14. The computer program product of claim 13, wherein the third plurality of road object observations are transmitted to a ramp processing algorithm component for further processing.

15. The computer program product of claim 12, wherein for determining the second plurality of road object observations from the first plurality of road object observations based on the filtering criteria, the operations further comprise:
determining the second plurality of road object observations based on the parallel link criteria, wherein the parallel link criteria comprises:
determining a fourth plurality of road object observations, wherein each road object observation in the fourth plurality of road object observations is associated with the second link and at least one fourth link, wherein the second link and the fourth link are on a same side of the first link; and
determining the second plurality of road object observations by removing the fourth plurality of road object observations from the first plurality of road object observations.

16. A method for identifying a link offset, the method comprising:
receiving a first plurality of road object observations associated with at least one road object for a first link, wherein the first link is associated with a second link;
determining a second plurality of road object observations from the first plurality of road object observations;
determining an offset distance based on the second plurality of road object observations; and
determining a first offset location on the first link and a second offset location on the second link for identifying the link offset, based on the determined offset distance.

17. The method of claim 16, wherein determining the second plurality of road object observations further comprises:
determining whether the second link is merging into the first link within a first threshold distance from a location associated with each of the first plurality of road object observations;
determining whether a heading difference data between a heading data associated with the first link and a heading data associated with the second link is less than a threshold heading difference data;
determining a merging location for the first link and the second link, in response to determining the second link is merging into the first link within the first threshold distance from the location associated with at least one of the first plurality of road object observations and the heading difference data between the heading data associated with the first link and the heading data associated with the second link is less than the threshold heading difference data; and
determining the second plurality of road object observations from the first plurality of road object observations such that the second plurality of road object observations are within the first threshold distance from the merging location.

18. The method of claim 17, wherein the offset distance is a distance from a location associated with a second road object observation of the second plurality of road object observations to the merging location.

19. The method of claim 17, wherein determining the first offset location on the first link and the second offset location on the second link for identifying the link offset further comprises:
determining a mean offset distance from the offset distance for each of the second plurality of road object observations;
determining the first offset location on the first link from the merging location, based on the mean offset distance;
determining the second offset location on the second link from the merging location, based on the mean offset distance; and
identifying a road segment portion of the first link from the first offset location to the merging location and a road segment portion of the second link from the second offset location to the merging location as the link offset.

20. The method of claim 16, further comprising updating a map database, based on the identified link offset.
